(19) United States
(12) Patent Application Publication
(10) Pub. No.: US 2017/0048605 A1
(43) Pub. Date: Feb. 16, 2017

(54) METHOD, APPARATUS, AND SYSTEM FOR SUPPLYING POWER TO ACTIVE NOISE REDUCTION HEADSET

(71) Applicant: Huawei Technologies Co., Ltd., Shenzhen (CN)

(72) Inventors: Depeng KOU, Shenzhen (CN); Huogen KUANG, Shanghai (CN); Zhonghui PENG, Shanghai (CN); Hai JIANG, Shenzhen (CN)

(73) Assignee: Huawei Technologies Co., Ltd., Shenzhen (CN)

(21) Appl. No.: 15/305,622

(22) PCT Filed: May 31, 2015
(86) PCT No.: PCT/CN2015/080446

§ 371 Date: Oct. 20, 2016

(30) Foreign Application Priority Data
May 30, 2014 (CN) PCT/CN2014/079011

(51) Int. Cl. H04R 1/10

(52) U.S. Cl. CPC H04R 1/1025; H04R 1/1041; H04R 2201/107; H04R 2460/01; H04R 2430/01

(57) ABSTRACT

Embodiments of the present invention relate to the field of electronic products and provide a method, an apparatus, and a system for supplying power to an active noise reduction headset, which can resolve a problem that a power supply operation of the active noise reduction headset is highly complex. The method for supplying power to an active noise reduction headset includes: receiving a signal of first voltage transmitted by a terminal; processing the signal of the first voltage to obtain a signal of second voltage, where the second voltage is less than the first voltage, and the signal of the second voltage is transmitted to a noise reduction chip of the active noise reduction headset, so that the noise reduction chip of the active noise reduction headset obtains the signal of the second voltage to implement a noise reduction function.

### CROSS-REFERENCE TO RELATED APPLICATIONS

This application is a National Stage of International Application No. PCT/CN2015/080446, filed on May 31, 2015, which claims priority to International Patent Application No. PCT/CN2014/079011, filed on May 30, 2014. Both of the aforementioned applications are hereby incorporated by reference in their entireties.

### TECHNICAL FIELD

The present invention relates to the field of electronic products, and in particular, to a method, an apparatus, and a system for supplying power to an active noise reduction headset.

### BACKGROUND

With development of electronic technologies, functions of electronic products are increasingly powerful. An active noise reduction headset generates, by using a noise reduction chip, a backward sound wave equal to noise, and neutralizes the noise by using the backward sound wave of the noise, so that a noise reduction effect is achieved. The active noise reduction headset includes an audio receiver, a noise reduction chip, and an audio output unit. The noise reduction chip is connected to both the audio receiver and the audio output unit, the audio receiver may be a tiny microphone, and the audio output unit may be a loudspeaker. It is assumed that a first audio input signal is a noise signal. After the audio receiver receives the first audio input signal and outputs the first audio input signal to the noise reduction chip, the noise reduction chip generates a second audio input signal, where the second audio input signal and the first audio input signal have a same amplitude and opposite phases. Then the noise reduction chip outputs the second audio input signal to the audio output unit, and the audio output unit outputs the second audio input signal, so that the first audio input signal is weakened or cancelled, thereby achieving an objective of shielding the noise by the active noise reduction headset. When the noise reduction chip weakens or cancels the received first audio input signal, power needs to be supplied to the noise reduction chip.

In the prior art, a lithium-ion battery may be disposed within the active noise reduction headset, and the lithium-ion battery supplies power to the noise reduction chip. In addition, a charger provided for charging the lithium-ion battery is configured for the active noise reduction headset. When the noise reduction chip works for a relatively long period of time, the lithium-ion battery also needs to supply power to the noise reduction chip within the relatively long period of time accordingly, and when the lithium-ion battery is out of power, the charger needs to charge the lithium-ion battery, so that the lithium-ion battery supplies power to the noise reduction chip. Therefore, a power supply operation of the active noise reduction headset is highly complex.

### SUMMARY

Embodiments of the present invention provide a method, an apparatus, and a system for supplying power to an active noise reduction headset, so as to resolve a problem that a power supply operation of the active noise reduction headset is highly complex.

To achieve the foregoing objective, the following technical solutions are used in the embodiments of the present invention:

According to a first aspect, an embodiment of the present invention provides a method for supplying power to an active noise reduction headset, where the active noise reduction headset is connected to a terminal, and the method includes:
receiving, by the active noise reduction headset, a signal of first voltage transmitted by the terminal; and
processing, by the active noise reduction headset, the signal of the first voltage to obtain a signal of second voltage, where the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function; where
the receiving a signal of first voltage transmitted by the terminal includes:
receiving, by the active noise reduction headset by using a microphone cable of the active noise reduction headset, the signal of the first voltage transmitted by the terminal.

In a first possible implementation manner of the first aspect, the processing, by the active noise reduction headset, the signal of the first voltage to obtain a signal of second voltage includes:
processing, by the active noise reduction headset, the signal of the first voltage to obtain a signal of third voltage, where the third voltage is less than the first voltage, and
the signal of the third voltage is transmitted to a rechargeable battery of the active noise reduction headset, so that the rechargeable battery stores the signal of the third voltage; and
processing, by the active noise reduction headset, the signal of the third voltage to obtain the signal of the second voltage, where the third voltage is greater than the second voltage.

With reference to the first aspect or the first possible implementation manner of the first aspect, in a second possible implementation manner, after the receiving a signal of first voltage transmitted by the terminal, the method further includes:
receiving, by the active noise reduction headset by using the microphone cable of the active noise reduction headset, a second trigger signal current triggered by a user; and
transmitting, by the active noise reduction headset, the second current trigger signal to the terminal by using the microphone cable of the active noise reduction headset, so that the terminal increases, according to the second current trigger signal, volume of a voice signal transmitted by the terminal to the active noise reduction headset.

With reference to any one of the first aspect, or the first and the second possible implementation manners of the first aspect, in a third possible implementation manner, after the receiving a signal of first voltage transmitted by the terminal, the method further includes:
receiving, by the active noise reduction headset by using the microphone cable of the active noise reduction headset, a third current trigger signal triggered by a user; and
transmitting, by the active noise reduction headset, the third current trigger signal to the terminal by using the microphone cable of the active noise reduction headset, so that the terminal decreases, according to the third current trigger signal, volume of a voice signal transmitted by the terminal to the active noise reduction headset.

According to a second aspect, an embodiment of the present invention provides a method for supplying power to an active noise reduction headset, where the active noise reduction headset is connected to a terminal, and the method includes:
obtaining, by the terminal, a signal of power source voltage provided by a power source of the terminal;
processing, by the terminal, the signal of the power source voltage of the terminal to obtain a signal of first voltage, where the power source voltage is less than the first voltage; and
transmitting, by the terminal, the signal of the first voltage to the active noise reduction headset, so that the active noise reduction headset processes the signal of the first voltage to obtain a signal of second voltage, where the signal of the second voltage is transmitted to a noise reduction chip of the active noise reduction headset, so that the noise reduction chip of the active noise reduction headset obtains the signal of the second voltage to implement a noise reduction function, where the second voltage is less than the first voltage.

In a first possible implementation manner of the second aspect, after the transmitting the signal of the first voltage to the active noise reduction headset, the method further includes:
receiving, by the terminal, a second trigger signal transmitted by a microphone cable of the active noise reduction headset, where the second trigger signal is a current generated by a user by means of triggering; and
increasing, by the terminal according to the second current trigger signal, volume of a voice signal transmitted by the terminal to the active noise reduction headset.

With reference to the second aspect or the first possible implementation manner of the second aspect, in a second possible implementation manner, after the transmitting the signal of the first voltage to the active noise reduction headset, the method further includes:
receiving, by the terminal, a third current trigger signal transmitted by a microphone cable of the active noise reduction headset, where the third trigger signal is generated by a user by means of triggering; and
decreasing, by the terminal according to the third current trigger signal, volume of a voice signal transmitted by the terminal to the active noise reduction headset.

According to a third aspect, an embodiment of the present invention provides an active noise reduction headset, where the active noise reduction headset is connected to a terminal, and the active noise reduction headset includes:
a receiver circuit, configured to: after the active noise reduction headset is connected to the terminal, receive a signal of first voltage transmitted by the terminal; and
a voltage step-down circuit, configured to process the signal of the first voltage to obtain a signal of second voltage, where the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function; where
the receiver circuit is specifically configured to:
receive, by using a microphone cable of the active noise reduction headset, the signal of the first voltage transmitted by the terminal.

In a first possible implementation manner of the third aspect, the voltage step-down circuit includes:
a first processing circuit, configured to process the signal of the first voltage to obtain a signal of third voltage, where the third voltage is less than the first voltage, and
the signal of the third voltage is transmitted to a rechargeable battery of the active noise reduction headset, so that the rechargeable battery stores the signal of the third voltage; and
a second processing circuit, configured to process the signal of the third voltage to obtain the signal of the second voltage, where the third voltage is greater than the second voltage.

With reference to the third aspect or the first possible implementation manner of the third aspect, in a second possible implementation manner,
the receiver circuit is further configured to receive, by using the microphone cable of the active noise reduction headset, a second current trigger signal triggered by a user; and
the active noise reduction headset further includes:
a transmission circuit, configured to transmit the second current trigger signal to the terminal by using the microphone cable of the active noise reduction headset, so that the terminal increases volume of a voice signal transmitted by the terminal to the active noise reduction headset.

With reference to any one of the third aspect, or the first and the second possible implementation manners of the third aspect, in a third possible implementation manner, the receiver circuit is further configured to receive, by using the microphone cable of the active noise reduction headset, a third current trigger signal triggered by a user; and
the active noise reduction headset further includes:
a transmission circuit, configured to transmit the third current trigger signal to the terminal by using the microphone cable of the active noise reduction headset, so that the terminal increases volume of a voice signal transmitted by the terminal to the active noise reduction headset.

With reference to the second possible implementation manner of the third aspect, in a fourth possible implementation manner,
a third button switch and a resistor R3, where one end of the resistor R3 is grounded, the other end of the resistor R3 is connected to the third button switch in series, the third button switch is connected to the microphone cable of the active noise reduction headset, and when the second current trigger signal indicating that a user triggers the active noise reduction headset is received by using the microphone cable of the active noise reduction headset, the third button switch is connected to the resistor R3.

With reference to either of the third possible implementation manner and the fourth possible implementation manner that are of the third aspect, in a fifth possible implementation manner,
a fifth button switch and a resistor R5, where one end of the resistor R5 is grounded, the other end of the resistor R5 is connected to the fifth button switch in series, the fifth button switch is connected to the microphone cable of the active noise reduction headset, and when the third current trigger signal indicating that a user triggers the active noise reduction headset is received by using the microphone cable of the active noise reduction headset, the fifth button switch is connected to the resistor R5.

With reference to the fifth possible implementation manner of the third aspect, in a sixth possible implementation manner,
when the first button switch is connected to the resistor R1, a current that flows through the resistor R1 is a first current;
when the third button switch is connected to the resistor R3, a current that flows through the resistor R3 is a second current;
when the fifth button switch is connected to the resistor R5, a current that flows through the resistor R5 is a third current, and
a value of the first current, a value of the second current, and a value of the third current are different from each other.

According to a fourth aspect, an embodiment of the present invention provides a terminal, where the terminal is connected to an active noise reduction headset, and the terminal includes:
a power source, configured to provide power source voltage to the terminal; and
a voltage step-up circuit, configured to process a signal of the power source voltage of the terminal to obtain a signal of first voltage, where the power source voltage is less than the first voltage; where
the voltage step-up circuit is further configured to: after the terminal is connected to the active noise reduction headset, transmit the signal of the first voltage to the active noise reduction headset, so that the active noise reduction headset processes the signal of the first voltage to obtain a signal of second voltage, where the signal of the second voltage is transmitted to a noise reduction chip of the active noise reduction headset, so that the noise reduction chip of the active noise reduction headset obtains the signal of the second voltage to implement a noise reduction function, where the second voltage is less than the first voltage; and
the voltage step-up circuit includes:
a voltage step-up chip, where an input end of the voltage step-up chip is connected to an output end of the power source of the terminal, and an output end of the voltage step-up chip is connected to a microphone cable of the active noise reduction headset.

In a first possible implementation manner of the fourth aspect, the terminal further includes:
a processing circuit, configured to receive a second current trigger signal transmitted by the microphone cable of the active noise reduction headset, where the second trigger signal is generated by a user by means of triggering; where
the processing circuit is further configured to increase, according to the second current trigger signal, volume of a voice signal transmitted by the terminal to the active noise reduction headset.

With reference to the fourth aspect, or the first possible implementation manner of the fourth aspect, in a second possible implementation manner, the processing circuit is further configured to receive a third current trigger signal transmitted by the microphone cable of the active noise reduction headset, where the third trigger signal is generated by a user by means of triggering; and
the processing circuit is further configured to decrease, according to the third current trigger signal, volume of a voice signal transmitted by the terminal to the active noise reduction headset.

According to a fifth aspect, an embodiment of the present invention provides a power supply system, including the foregoing active noise reduction headset and the foregoing terminal.

The embodiments of the present invention provide a method, an apparatus, and a system for supplying power to an active noise reduction headset, where the method for supplying power to an active noise reduction headset includes: receiving, by the active noise reduction headset, a signal of first voltage transmitted by the terminal; processing, by the active noise reduction headset, the signal of the first voltage to obtain a signal of second voltage, where the second voltage is less than the first voltage, and the signal of the second voltage is transmitted to a noise reduction chip of the active noise reduction headset, so that the noise reduction chip of the active noise reduction headset obtains the signal of the second voltage to implement a noise reduction function. In this way, after an active noise reduction headset is connected to a terminal, the active noise reduction headset may receive a signal of first voltage transmitted by the terminal, and then process the signal of the first voltage to obtain a signal of second voltage, so that a noise reduction chip of the active noise reduction headset obtains the signal of the second voltage to implement a noise reduction function. Therefore, the terminal connected to the active noise reduction headset supplies power to the active noise reduction headset, which can effectively resolve a problem that a power supply operation of the active noise reduction headset is highly complex.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flowchart of a method for supplying power to an active noise reduction headset according to an embodiment of the present invention;

FIG. 2 is a flowchart of another method for supplying power to an active noise reduction headset according to an embodiment of the present invention;

FIG. 3 is a flowchart of still another method for supplying power to an active noise reduction headset according to an embodiment of the present invention;

FIG. 4 is a schematic structural diagram of an active noise reduction headset according to an embodiment of the present invention;

FIG. 5 is a schematic structural diagram of another active noise reduction headset according to an embodiment of the present invention;

FIG. 6 is a schematic structural diagram of a voltage step-down circuit according to an embodiment of the present invention;

FIG. 7 is a schematic structural diagram of still another active noise reduction headset according to an embodiment of the present invention;

FIG. 8 is a schematic structural diagram of a terminal according to an embodiment of the present invention;

FIG. 9 is a schematic structural diagram of another terminal according to an embodiment of the present invention;

FIG. 10 is a schematic structural diagram of a mobile phone according to an embodiment of the present invention;

FIG. 11 is a schematic structural diagram of yet another active noise reduction headset according to an embodiment of the present invention;

FIG. 12 is a schematic structural diagram of still yet another active noise reduction headset according to an embodiment of the present invention;

FIG. 13 is a schematic structural diagram of another mobile phone according to an embodiment of the present invention;

FIG. 14 is a schematic structural diagram of a power supply system according to an embodiment of the present invention;

FIG. 15 is a schematic structural diagram of still another active noise reduction headset according to an embodiment of the present invention;

FIG. 16 is a schematic structural diagram of a dashed line part of the active noise reduction headset in FIG. 15; and

FIG. 17 is a schematic structural diagram of still another active noise reduction headset according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

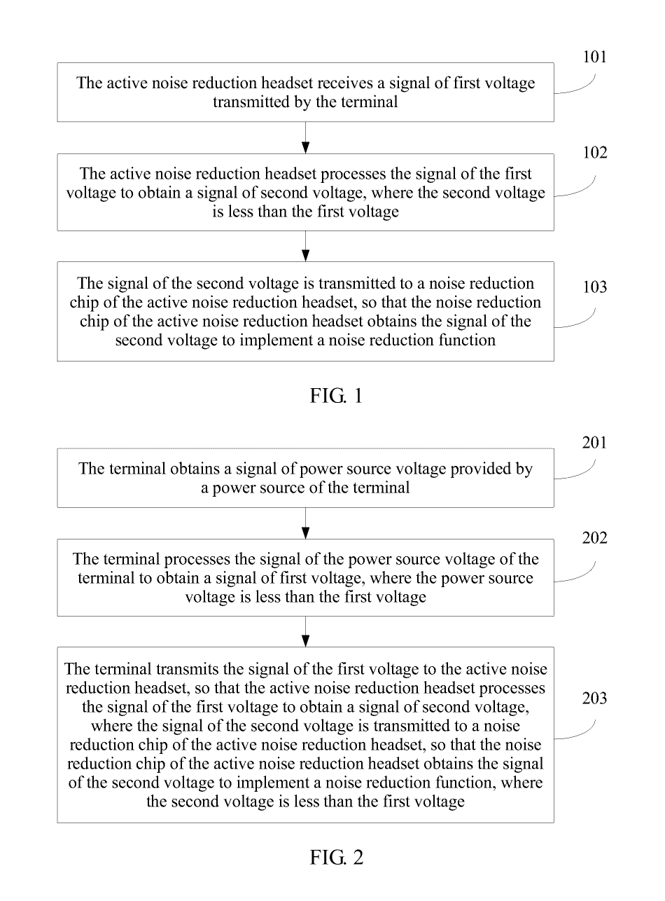

An embodiment of the present invention provides a method for supplying power to an active noise reduction headset, where the active noise reduction headset is connected to a terminal. As shown in FIG. 1, the method includes the following steps:

Step 101: The active noise reduction headset receives a signal of first voltage transmitted by the terminal.

The signal of the first voltage transmitted by the terminal may be received by using a microphone cable of the active noise reduction headset.

Step 102: The active noise reduction headset processes the signal of the first voltage to obtain a signal of second voltage, where the second voltage is less than the first voltage.

The active noise reduction headset may directly process the signal of the first voltage to obtain the signal of the second voltage; or may first process the signal of the first voltage to obtain a signal of third voltage, where the third voltage is less than the first voltage, then the signal of the third voltage is transmitted to a rechargeable battery of the active noise reduction headset, so that the rechargeable battery stores the signal of the third voltage, and the signal of the third voltage is processed to obtain the signal of the second voltage, where the third voltage is greater than the second voltage.

Step 103: The signal of the second voltage is transmitted to a noise reduction chip of the active noise reduction headset, so that the noise reduction chip of the active noise reduction headset obtains the signal of the second voltage to implement a noise reduction function.

The signal of the first voltage and the first voltage described in this application both refer to a value of the first voltage. The signal of the second voltage and the second voltage both refer to a value of the second voltage. The signal of the third voltage and the third voltage both refer to a value of the third voltage. For example, when the first voltage is 2.8 V, the signal of the first voltage and the first voltage are both 2.8.

In this way, after an active noise reduction headset is connected to a terminal, the active noise reduction headset may receive a signal of first voltage transmitted by the terminal, and then process the signal of the first voltage to obtain a signal of second voltage, so that a noise reduction chip of the active noise reduction headset obtains the signal of the second voltage to implement a noise reduction function. Therefore, the terminal connected to the active noise reduction headset supplies power to the active noise reduction headset, which can effectively resolve a problem that a power supply operation of the active noise reduction headset is highly complex.

An embodiment of the present invention provides a method for supplying power to an active noise reduction headset, where the active noise reduction headset is connected to a terminal. As shown in FIG. 2, the method includes the following steps:

Step 201: The terminal obtains a signal of power source voltage provided by a power source of the terminal.

Step 202: The terminal processes the signal of the power source voltage of the terminal to obtain a signal of first voltage, where the power source voltage is less than the first voltage.

Step 203: The terminal transmits the signal of the first voltage to the active noise reduction headset, so that the active noise reduction headset processes the signal of the first voltage to obtain a signal of second voltage, where the signal of the second voltage is transmitted to a noise reduction chip of the active noise reduction headset, so that the noise reduction chip of the active noise reduction headset obtains the signal of the second voltage to implement a noise reduction function, where the second voltage is less than the first voltage.

In this way, after an active noise reduction headset is connected to a terminal, the terminal may transmit a signal of first voltage to the active noise reduction headset. After receiving the signal of the first voltage, the active noise reduction headset processes the signal of the first voltage to obtain a signal of second voltage, so that a noise reduction chip of the active noise reduction headset obtains the signal of the second voltage to implement a noise reduction function. Therefore, the terminal connected to the active noise reduction headset supplies power to the active noise reduction headset, which can effectively resolve a problem that a power supply operation of the active noise reduction headset is highly complex.

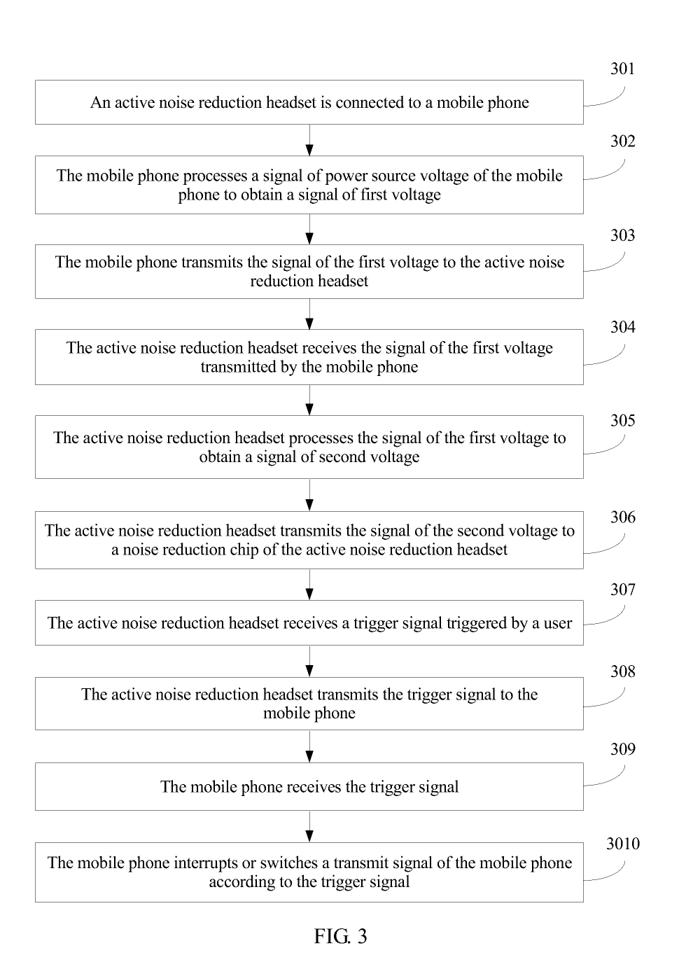

An embodiment of the present invention provides a method for supplying power to an active noise reduction headset, and it is assumed that a terminal is a mobile phone. As shown in FIG. 3, the method includes the following steps:

Step 301: The active noise reduction headset is connected to the mobile phone.

A headset plug of the active noise reduction headset is inserted into a headset jack of the mobile phone, so that the active noise reduction headset is connected to the mobile phone.

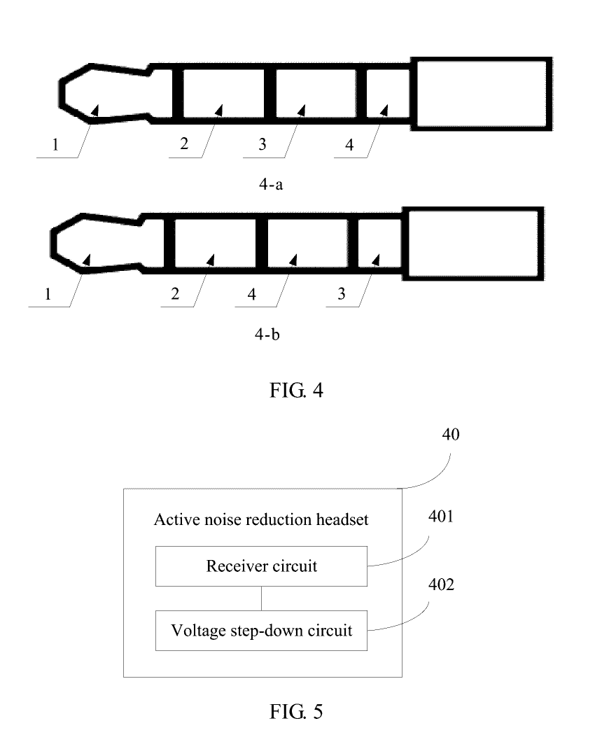

In the prior art, a size of the headset plug may be 3.5 millimeters with four segments. As shown in FIG. 4, there may be two connection methods for headset plug cables. A first method is shown in FIG. 4-a, which sequentially includes an audio-left channel cable (L) 1, an audio-right channel cable (R) 2, a microphone cable (MIC) 3, and a ground cable (GND) 4 from left to right. A second manner is shown in FIG. 4-a, which sequentially includes an audio-left channel cable (L) 1, an audio-right channel cable (R) 2, a ground cable (GND) 4, and a microphone cable (MIC) 3 from left to right. When the active noise reduction headset is connected to the mobile phone, a pin of the headset plug of the active noise reduction headset must match a pin of the headset jack of the mobile phone, so that the mobile phone connected to the active noise reduction headset supplies power to the active noise reduction headset.

Step 302: The mobile phone processes a signal of power source voltage of the mobile phone to obtain a signal of first voltage.

The mobile phone increases the power source voltage of the power source of the mobile phone to obtain the signal of the first voltage, where the signal of the first voltage is a signal of output voltage of the mobile phone. Generally, the power source voltage of the mobile phone ranges from 3.2 V to 4.2 V, and the output voltage of the mobile phone is 5 V.

Step 303: The mobile phone transmits the signal of the first voltage to the active noise reduction headset.

The mobile phone transmits the signal of the first voltage to the active noise reduction headset by using a microphone cable of the active noise reduction headset.

Step 304: The active noise reduction headset receives the signal of the first voltage transmitted by the mobile phone.

The active noise reduction headset receives, by using the microphone cable of the active noise reduction headset, the signal of the first voltage transmitted by the mobile phone.

It should be noted that the active noise reduction headset according to the present invention needs to be an active noise reduction headset that has a microphone function, that is, the active noise reduction headset has the microphone cable. Therefore, the microphone cable of the active noise reduction headset is reused as a power cable of the active noise reduction headset, and the mobile phone supplies power to the active noise reduction headset by using the microphone cable of the active noise reduction headset.

Step 305: The active noise reduction headset processes the signal of the first voltage to obtain a signal of second voltage.

The active noise reduction headset may directly process the signal of the first voltage to obtain the signal of the second voltage, where the signal of the second voltage is transmitted to a noise reduction chip of the active noise reduction headset, and the second voltage is less than the first voltage.

Specially, first, the active noise reduction headset may process the signal of the first voltage to obtain a signal of third voltage, where the third voltage is less than the first voltage; then the signal of the third voltage is transmitted to a rechargeable battery and a voltage step-down chip that are of the active noise reduction headset, so that the rechargeable battery stores the signal of the third voltage, and the voltage step-down chip processes the signal of the third voltage to obtain the signal of the second voltage, where the third voltage is greater than the second voltage. In this way, if the active noise reduction headset is further connected to a mobile phone that cannot supply power to the active noise reduction headset, the active noise reduction headset can use electric energy stored by the rechargeable battery of the active noise reduction headset to supply power to the active noise reduction headset; or if the microphone cable of the active noise reduction headset is occupied, that is, the mobile phone is in a conversation state of a voice service, after receiving a voice signal, the active noise reduction headset outputs the received voice signal by using the microphone cable of the active noise reduction headset, and the active noise reduction headset can use the electric energy stored by the rechargeable battery of the active noise reduction headset to supply power to the active noise reduction headset. Compared with the prior art, the active noise reduction headset provided in the present invention can obtain the electric energy in real time, so as to implement a noise reduction function, which can avoid changing a dry cell of the active noise reduction headset frequently because of power supply needed by the active noise reduction headset.

Step 306: The active noise reduction headset transmits the signal of the second voltage to a noise reduction chip of the active noise reduction headset.

The noise reduction chip of the active noise reduction headset obtains the signal of the second voltage to implement the noise reduction function.

Specially, according to this embodiment of the present invention, the microphone cable of the active noise reduction headset is used as the power cable of the active noise reduction headset, and in a case in which the microphone cable of the active noise reduction headset is not occupied, the mobile phone connected to the active noise reduction headset can supply power to the active noise reduction headset. Optionally, the mobile phone connected to the active noise reduction headset can charge the rechargeable battery of the active noise reduction headset, so as to supply power to the active noise reduction headset, so that the noise reduction chip of the active noise reduction headset obtains the signal of the second voltage to implement the noise reduction function.

In a case in which the microphone cable of the active noise reduction headset is occupied, the active noise reduction headset can use the signal of the third voltage stored by the rechargeable battery of the active noise reduction headset, and power is supplied to the active noise reduction headset by using the electric energy stored by the rechargeable battery of the active noise reduction headset, so that the noise reduction chip of the active noise reduction headset obtains the signal of the second voltage to implement the noise reduction function.

It should be noted that, in the case in which the microphone cable of the active noise reduction headset is occupied, for example, when the mobile phone is in a conversation state of a voice service, the microphone cable of the active noise reduction headset is occupied because after a microphone of the active noise reduction headset receives a voice signal of a user, the voice signal is output by using the microphone cable of the active noise reduction headset. The case in which the microphone cable of the active noise reduction headset is not occupied refers to, for example, a case in which the user does not use the microphone of the active noise reduction headset when the mobile phone is in a standby state or not in a conversation state of a voice service.

Step 307: The active noise reduction headset receives at least one of the following currents flowing through the microphone cable of the active noise reduction headset: a first current, a second current, and a third current.

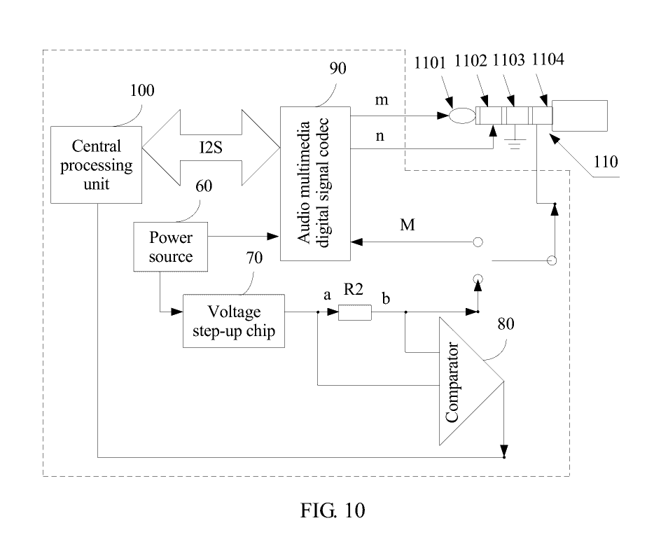

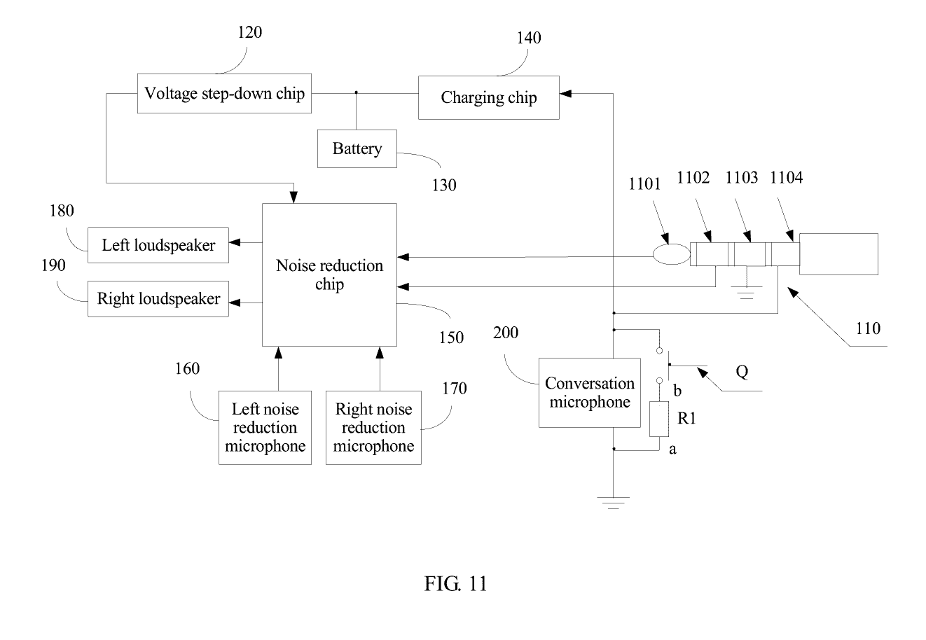

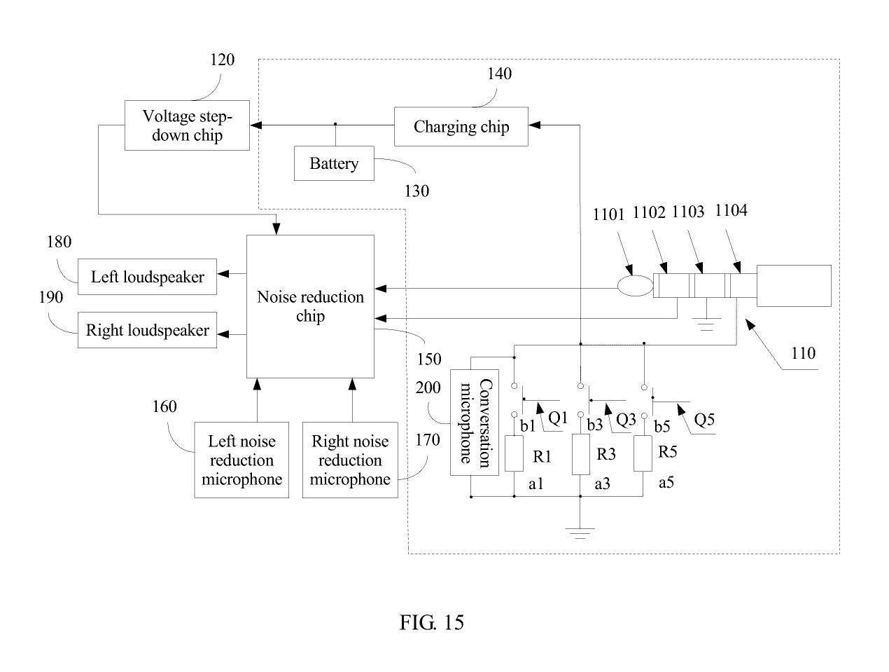

The user can press an answering button or a switching button disposed in the active noise reduction headset. Because the answering button or the switching button Q is pressed, a resistor R1 in FIG. 11 and a resistor R2 in FIG. 10 are connected in series, and the active noise reduction headset receives, by using the microphone cable of the active noise reduction headset, the first current that flows through the microphone cable of the active noise reduction headset; or
the user can press a volume increase button (for example, a button Q3 in FIG. 15) disposed in the active noise reduction headset; a resistor R3 in FIG. 15 and the resistor R2 in FIG. 10 are connected in series, and the active noise reduction headset receives, by using the microphone cable of the active noise reduction headset, the second current that flows through the microphone cable of the active noise reduction headset; or
the user can press a volume decrease button (for example, a button Q5 in FIG. 15) disposed in the active noise reduction headset; a resistor R5 in FIG. 15 and the resistor R2 in FIG. 10 are connected in series, and the active noise reduction headset receives, by using the microphone cable of the active noise reduction headset, the third current that flows through the microphone cable of the active noise reduction headset.

Step 308: The active noise reduction headset transmits at least one current of the first current, the second current, and the third current to the mobile phone.

The active noise reduction headset transmits the at least one current to the mobile phone by using the microphone cable of the active noise reduction headset.

Step 309: The mobile phone receives the at least one current.

The mobile phone receives the at least one current by using the microphone cable of the active noise reduction headset.

Step 3010: The mobile phone performs corresponding processing according to a corresponding current.

The mobile phone interrupts or switches a transmit signal of the mobile phone when the mobile phone receives the first current.

When the mobile phone receives the second current, the mobile phone increases volume of a voice signal transmitted by the mobile phone to the active noise reduction headset.

When the mobile phone receives the third current, the mobile phone decreases volume of a voice signal transmitted by the mobile phone to the active noise reduction headset.

The mobile phone interrupts or switches the transmit signal of the mobile phone according to the first current, which includes but is not limited to suspending or terminating the transmit signal of the mobile phone, where the transmit signal is a data signal or a voice signal transmitted by the mobile phone to the active noise reduction headset.

For example, when the mobile phone is playing a multimedia file such as a song or a video, if the user presses the answering button disposed in the active noise reduction headset, the active noise reduction headset receives the first current by using the microphone cable of the active noise reduction headset, then transmits the first current to the mobile phone, and the mobile phone may suspend or stop, according to the received first current, the song or video or the like that is being played; or when the mobile phone is playing a multimedia file such as a song or a video, if the user presses the switching button disposed in the active noise reduction headset, the active noise reduction headset receives, by using the microphone cable of the active noise reduction headset, the first current triggered by the user, then transmits the first current to the mobile phone, and the mobile phone may switch, according to the received first current, the song or video or the like that is being played; or when the mobile phone receives a call signal in a standby state, if the user presses the answering button disposed in the active noise reduction headset, the active noise reduction headset receives, by using the microphone cable of the active noise reduction headset, the first current triggered by the user, then transmits the first current to the mobile phone, and the mobile phone may answer an incoming call according to the received first current; or when the mobile phone is transmitting a voice signal in a conversation state, if the user presses the answering button disposed in the active noise reduction headset, the active noise reduction headset receives, by using the microphone cable of the active noise reduction headset, the first current triggered by the user, and transmits the first current to the mobile phone, the mobile phone may break a conversation according to the received first current. The switching button and the answering button may be a same button or two buttons.

Optionally, the user may further trigger a virtual button or a physical button of the mobile phone. After receiving the first current, the mobile phone may interrupt or switch a transmit signal of the mobile phone according to the first current, which includes but is not limited to suspending or terminating the transmit signal of the mobile phone, where the transmit signal is a data signal or a voice signal transmitted by the mobile phone to the active noise reduction headset;
or
the mobile phone increases, according to a second current received by using the microphone cable of the active noise reduction headset, volume of a voice signal transmitted by the mobile phone to the active noise reduction headset.

For example, when the mobile phone is answering or making a call, if the user presses a button used to increase volume of a voice signal transmitted by the terminal to the active noise reduction headset, volume of the call that is being answered or made by the mobile phone may be correspondingly increased. For another example, when the user is playing, by using the mobile phone, an audio file or a video stored in the mobile phone, or a broadcast program or web television played online by using the Internet, if the user presses a button used to increase volume of a voice signal transmitted by the terminal to the active noise reduction headset, the mobile phone may increase play volume of the video or audio file stored in the mobile phone, or the mobile phone may increase play volume of the broadcast program or web television played online by using the Internet.

Optionally, the user may further trigger a virtual button or a physical button of the mobile phone. After receiving the second current, the mobile phone may increase, according to the second current, volume of a voice signal transmitted by the terminal to the active noise reduction headset;
or
the mobile phone decreases, according to a third current received by using the microphone cable of the active noise reduction headset, volume of a voice signal transmitted by the terminal to the active noise reduction headset.

For example, when the mobile phone is answering or making a call, if the user presses a button used to decrease volume of a voice signal transmitted by the terminal to the active noise reduction headset, volume of the call that is being answered or made by the mobile phone may be correspondingly decreased. For another example, when the user is playing, by using the mobile phone, an audio file or a video stored in the mobile phone, or a broadcast program or web television played online by using the Internet, if the user presses a button used to decrease volume of a voice signal transmitted by the terminal to the active noise reduction headset, the mobile phone may decrease play volume of the video or audio file stored in the mobile phone, or the mobile phone may decrease play volume of the broadcast program or web television played online by using the Internet.

Optionally, the user may further trigger a virtual button or a physical button of the mobile phone. After receiving the third current, the mobile phone may decrease, according to the third current, volume of a voice signal transmitted by the terminal to the active noise reduction headset.

Steps 307-3010 are further optional.

According to the method for supplying power to an active noise reduction headset provided in this embodiment of the present invention, after the active noise reduction headset is connected to a mobile phone, first, the mobile phone processes a signal of power source voltage of the mobile phone to obtain a signal of first voltage, and transmits the signal of the first voltage to the active noise reduction headset; then the active noise reduction headset receives the signal of the first voltage transmitted by the mobile phone, processes the signal of the first voltage to obtain a signal of second voltage, and transmits the signal of the second voltage to a noise reduction chip of the active noise reduction headset, so that the noise reduction chip of the active noise reduction headset obtains the signal of the second voltage to implement a noise reduction function. The active noise reduction headset may further receive a current that flows through, after a button of the active noise reduction headset is pressed, a microphone cable of the active noise reduction headset, and transmits the current to the mobile phone; after receiving the current, the mobile phone interrupts or switches a transmit signal of the mobile phone according to the current (for example, a first current), or after receiving the current used to trigger the mobile phone by a user, the mobile phone interrupts or switches a transmit signal of the mobile phone according to the first current; or the mobile phone increases, according to the current (for example, a second current), volume of a voice signal transmitted by the mobile phone to the active noise reduction headset; or the mobile phone decreases, according to the current (for example, a third current), volume of a voice signal transmitted by the mobile phone to the active noise reduction headset. Compared with the prior art, the mobile phone connected to the active noise reduction headset can supply power to the active noise reduction headset, so that the noise reduction chip of the active noise reduction headset implements the noise reduction function, which can effectively resolve a problem that a power supply operation of the active noise reduction headset is highly complex.

An embodiment of the present invention provides an active noise reduction headset 40, where the active noise reduction headset is connected to a terminal. As shown in FIG. 5, the active noise reduction headset 40 includes:
a receiver circuit 401, configured to receive a signal of first voltage transmitted by the terminal; and
a voltage step-down circuit 402, configured to process the signal of the first voltage to obtain a signal of second voltage, where the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function.

In this way, after an active noise reduction headset is connected to a terminal, the active noise reduction headset may receive a signal of first voltage transmitted by the terminal, and then process the signal of the first voltage to obtain a signal of second voltage, so that a noise reduction chip of the active noise reduction headset obtains the signal of the second voltage to implement a noise reduction function. Therefore, the terminal connected to the active noise reduction headset supplies power to the active noise reduction headset, which can effectively resolve a problem that a power supply operation of the active noise reduction headset is highly complex.

The receiver circuit 401 is specifically configured to:
receive, by using a microphone cable of the active noise reduction headset, the signal of the first voltage transmitted by the terminal.

The receiver circuit 401 may be understood as the microphone cable and/or a headset plug of the active noise reduction headset.

The voltage step-down circuit 402 includes:
a voltage step-down chip, where an input end of the voltage step-down chip is connected to the microphone cable of the active noise reduction headset, and an output end of the voltage step-down chip is connected to an input end of the noise reduction chip of the active noise reduction headset.

In an embodiment, the voltage step-down chip is configured to process the received signal of the first voltage transmitted by the terminal, so as to obtain the signal of the second voltage, where the second voltage is less than the first voltage. Then the signal of the second voltage is transmitted to the noise reduction chip of the active noise reduction headset, so that the noise reduction chip of the active noise reduction headset obtains the signal of the second voltage to implement a noise reduction function.

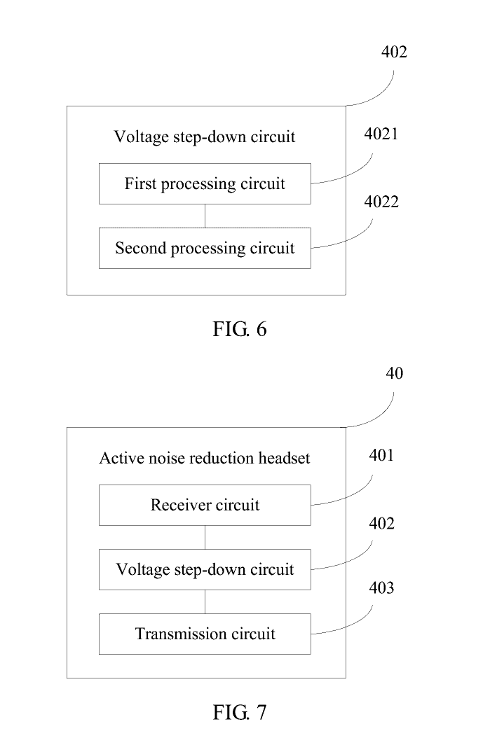

In another embodiment, as shown in FIG. 6, the voltage step-down circuit 402 includes:
a first processing circuit 4021, configured to process the signal of the first voltage to obtain a signal of third voltage, where the third voltage is less than the first voltage, and
the signal of the third voltage is transmitted to a rechargeable battery of the active noise reduction headset, so that the rechargeable battery stores the signal of the third voltage; and
a second processing circuit 4022, configured to process the signal of the third voltage to obtain the signal of the second voltage, where the third voltage is greater than the second voltage.

The first processing circuit 4021 includes a charging chip, and the second processing circuit 4022 includes a voltage step-down chip.

An input end of the charging chip is connected to the microphone cable of the active noise reduction headset, one end of the rechargeable battery is separately connected to an output end of the charging chip and the input end of the voltage step-down chip, the other end of the rechargeable battery is grounded, and the output end of the voltage step-down chip is connected to the input end of the noise reduction chip of the active noise reduction headset.

The receiver circuit 401 is further configured to receive at least one current of a first current, a second current, and a third current by using the microphone cable of the active noise reduction headset.

As shown in FIG. 7, the active noise reduction headset 40 further includes:
a transmission circuit 403, configured to transmit the first current to the terminal by using the microphone cable of the active noise reduction headset, so that the terminal interrupts or switches a transmit signal of the terminal according to the first current, where the transmit signal is a data signal or a voice signal transmitted by the terminal to the active noise reduction headset;
or
a transmission circuit 403, configured to transmit the second current to the terminal by using the microphone cable of the active noise reduction headset, so that the terminal increases, according to the second current, volume of a voice signal transmitted by the terminal to the active noise reduction headset;
or
a transmission circuit 403, configured to transmit the third current to the terminal by using the microphone cable of the active noise reduction headset, so that the terminal decreases, according to the third current, volume of a voice signal transmitted by the terminal to the active noise reduction headset.

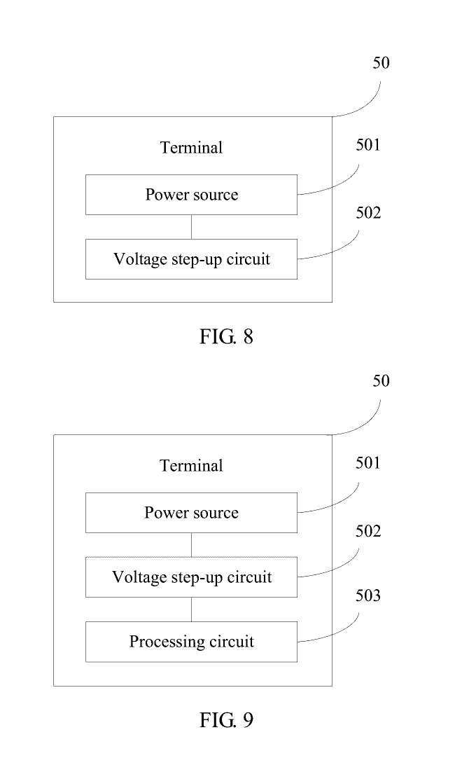

The transmission circuit 403 may include:
a button switch Q1 and a resistor R1 shown in FIG. 15, where one end of the resistor R1 is grounded, the other end of the resistor R1 is connected to the button switch in series, the button switch is connected to the microphone cable of the active noise reduction headset, when the button switch Q1 is pressed, the button switch Q1 is connected to the resistor R1, and the first current of the active noise reduction headset is received by using the microphone cable of the active noise reduction headset;
a button switch Q3 and a resistor R3 shown in FIG. 15, where one end of the resistor R3 is grounded, the other end of the resistor R3 is connected to the button switch in series, the button switch Q3 is connected to the microphone cable of the active noise reduction headset, when the button switch Q3 is pressed, the button switch Q3 is connected to the resistor R3, and the second current of the active noise reduction headset is received by using the microphone cable of the active noise reduction headset; or
a button switch Q5 and a resistor R5 shown in FIG. 15, where one end of the resistor R5 is grounded, the other end of the resistor R5 is connected to the button switch in series, the button switch Q5 is connected to the microphone cable of the active noise reduction headset, when the button switch Q5 is pressed, the button switch Q5 is connected to the resistor R5, and the third current of the active noise reduction headset is received by using the microphone cable of the active noise reduction headset. An embodiment of the present invention provides a terminal 50, where the terminal is connected to an active noise reduction headset. As shown in FIG. 8, the terminal 50 includes:
a power source 501, configured to provide power source voltage to the terminal; and
a voltage step-up circuit 502, configured to process a signal of the power source voltage of the terminal to obtain a signal of first voltage, where the power source voltage is less than the first voltage.

The voltage step-up circuit 502 is further configured to transmit the signal of the first voltage to the active noise reduction headset, so that the active noise reduction headset processes the signal of the first voltage to obtain a signal of second voltage, where the signal of the second voltage is transmitted to a noise reduction chip of the active noise reduction headset, so that the noise reduction chip of the active noise reduction headset obtains the signal of the second voltage to implement a noise reduction function, where the second voltage is less than the first voltage.

In this way, after an active noise reduction headset is connected to a terminal, the terminal may transmit a signal of first voltage to the active noise reduction headset. After receiving the signal of the first voltage, the active noise reduction headset processes the signal of the first voltage to obtain a signal of second voltage, so that a noise reduction chip of the active noise reduction headset obtains the signal of the second voltage to implement a noise reduction function. Therefore, the terminal connected to the active noise reduction headset supplies power to the active noise reduction headset, which can effectively resolve a problem that a power supply operation of the active noise reduction headset is highly complex.

The voltage step-up circuit 502 includes:
a voltage step-up chip, where an input end of the voltage step-up chip is connected to an output end of the power source of the terminal, and an output end of the voltage step-up chip is connected to a microphone cable of the active noise reduction headset.

As shown in FIG. 9, the terminal 50 may further include:
a processing circuit 503, configured to receive a first current that flows through the microphone cable of the active noise reduction headset; because an answering button or a switching button Q is pressed, a resistor R1 in FIG. 11 and a resistor R2 in FIG. 10 are connected in series, and the active noise reduction headset receives, by using the microphone cable of the active noise reduction headset, the first current that flows through the microphone cable of the active noise reduction headset;
or
a processing circuit 503, configured to receive a second current that flows through the microphone cable of the active noise reduction headset; because an answering button or a switching button Q3 is pressed, a resistor R3 in FIG. 15 and a resistor R2 in FIG. 10 are connected in series, and the active noise reduction headset receives, by using the microphone cable of the active noise reduction headset, the second current that flows through the microphone cable of the active noise reduction headset;
or
a processing circuit 503, configured to receive a third current that flows through the microphone cable of the active noise reduction headset; because an answering button or a switching button Q5 is pressed, a resistor R5 in FIG. 15 and a resistor R2 in FIG. 10 are connected in series, and the active noise reduction headset receives, by using the microphone cable of the active noise reduction headset, the third current that flows through the microphone cable of the active noise reduction headset.

The processing circuit 503 is further configured to interrupt or switch a transmit signal of the terminal according to the first current, where the transmit signal is a data signal or a voice signal transmitted by the terminal to the active noise reduction headset;
or
the processing circuit 503 is further configured to increase, according to the second current, volume of a voice signal transmitted by the terminal to the active noise reduction headset;
or
the processing circuit 503 is further configured to decrease, according to the third current, volume of a voice signal transmitted by the terminal to the active noise reduction headset.

The processing circuit 503 in FIG. 9 includes:
the resistor R2 and a comparator in FIG. 10.

One end of the resistor R2 is separately connected to the output end of the voltage step-up chip and a first input end of the comparator, and the other end of the resistor R2 is separately connected to the microphone cable of the active noise reduction headset and a second input end of the comparator.

It should be noted that, after the terminal receives a different current transmitted by the microphone cable of the active noise reduction headset, the comparator obtains a different voltage difference by comparing voltage at two ends of the resistor R2, and obtains a different level signal according to the different voltage difference, for example, may obtain a first level, a second level, and a third level. The terminal may interrupt or switch a transmit signal of the terminal according to the first level; or may increase, according to the second level, volume of a voice signal transmitted by the terminal to the active noise reduction headset; or may decrease, according to the third level, volume of a voice signal transmitted by the terminal to the active noise reduction headset.

When the button Q1 in the active noise reduction headset shown in FIG. 15 is pressed, a resistor R1 in FIG. 15 and the resistor R2 in a mobile phone shown in FIG. 10 are connected in series, and the terminal receives the first current that is transmitted by the microphone cable of the active noise reduction headset and that flows through the microphone cable of the active noise reduction headset. A voltage difference between two ends of the resistor R2 in FIG. 10 is obtained according to the first current that flows through the resistor R2 in FIG. 10, and the voltage difference is input into the comparator 80 in FIG. 10. The comparator 80 in FIG. 10 outputs a first level according to the input voltage difference, and inputs the first level to a central processing unit 100 of the mobile phone, so that the central processing unit 100 of the mobile phone controls an audio multimedia digital signal codec 90 to output a first control signal, and sends the first control signal to a headset plug 110 of the active noise reduction headset, so as to control interruption or switch of the transmit signal of the terminal.

When the button Q3 in the active noise reduction headset shown in FIG. 15 is pressed, the resistor R3 in FIG. 15 and the resistor R2 in the mobile phone shown in FIG. 10 are connected in series, and the terminal receives the second current that is transmitted by the microphone cable of the active noise reduction headset and that flows through the microphone cable of the active noise reduction headset. A voltage difference between two ends of the resistor R2 in FIG. 10 is obtained according to the second current that flows through the resistor R2 in FIG. 10, and the voltage difference is input into the comparator 80 in FIG. 10. The comparator 80 in FIG. 10 outputs a second level according to the input voltage difference, and inputs the second level to the central processing unit 100 of the mobile phone, so that the central processing unit 100 of the mobile phone controls the audio multimedia digital signal codec 90 to output a second control signal, and sends the second control signal to the headset plug 110 of the active noise reduction headset, so as to control increase of volume of a voice signal transmitted by the terminal to the active noise reduction headset.

When the button Q5 in the active noise reduction headset shown in FIG. 15 is pressed, the resistor R5 in FIG. 15 and the resistor R2 in the mobile phone shown in FIG. 10 are connected in series, and the terminal receives the third current that is transmitted by the microphone cable of the active noise reduction headset and that flows through the microphone cable of the active noise reduction headset. A voltage difference between two ends of the resistor R2 in FIG. 10 is obtained according to the third current that flows through the resistor R2 in FIG. 10, and the voltage difference is input into the comparator 80 in FIG. 10. The comparator 80 in FIG. 10 outputs the third level according to the input voltage difference, and inputs the third level to the central processing unit 100 of the mobile phone, so that the central processing unit 100 of the mobile phone controls the audio multimedia digital signal codec 90 to output a third control signal, and sends the third control signal to the headset plug 110 of the active noise reduction headset, so as to control decrease of volume of a voice signal transmitted by the terminal to the active noise reduction headset.

In an embodiment, exemplarily, it is assumed that a terminal is a mobile phone, and it is assumed that cables of a headset plug of an active noise reduction headset are successively an audio-left channel cable, an audio-right channel cable, a ground cable, and a microphone cable from left to right, and the active noise reduction headset is connected to the mobile phone, that is, the headset plug of the active noise reduction headset is inserted into a headset jack of the mobile phone. As shown in FIG. 10, the mobile phone includes: a power source 60, a voltage step-up chip 70, a resistor R2, a comparator 80, an audio multimedia digital signal codec 90, and a central processing unit 100, that is, components included in a dashed line box in FIG. 10.

The power source 60 is separately connected to an input end of the voltage step-up chip 70 and an input end of the audio multimedia digital signal codec 90; an end a of the resistor R2 is separately connected to an output end of the voltage step-up chip 70 and a first input end of the comparator 80, and an end b of the resistor R2 is connected to a second input end of the comparator 80; an output end of the comparator 80 is connected to the central processing unit 100; a left audio output end m of the audio multimedia digital signal codec 90 is connected to an audio-left channel cable 1101 of a headset plug 110 of the active noise reduction headset, a right audio output end n of the audio multimedia digital signal codec 90 is connected to an audio-right channel cable 1102 of the headset plug 110 of the active noise reduction headset, and the audio multimedia digital signal codec 90 is connected to the central processing unit 100 by using an audio bus I2S. It should be noted that, a microphone cable 1104 of the headset plug 110 of the active noise reduction headset may be connected to a headset microphone cable M of the audio multimedia digital signal codec 90, or may be connected to the end b of the resistor R2; and the power source may be a lithium-ion battery.

As shown in FIG. 11, the active noise reduction headset may include: the headset plug 110 of the active noise reduction headset, a voltage step-down chip 120, a battery 130, a charging chip 140, a noise reduction chip 150, a left noise reduction microphone 160, a right noise reduction microphone 170, a left loudspeaker 180, a right loudspeaker 190, a conversation microphone 200, a resistor R1, and a button switch Q. The headset plug 110 of the active noise reduction headset includes the audio-left channel cable 1101, the audio-right channel cable 1102, a ground cable 1103, and the microphone cable 1104.

The microphone cable 1104 of the active noise reduction headset is connected to an input end of the charging chip 140 and one end of the conversation microphone 200, the other end of the conversation microphone 200 is grounded, an output end of the charging chip 140 is connected to an input end of the voltage step-down chip 120, the battery 130 is separately connected to the output end of the charging chip 140 and the input end of the voltage step-down chip 120, an output end of the voltage step-down chip 120 is connected to the noise reduction chip 150, the audio-right channel cable 1102 of the active noise reduction headset is connected to an audio-right channel input end of the noise reduction chip 150, an audio-right channel output end of the noise reduction chip 150 is connected to the right loudspeaker 190, the audio-left channel cable 1101 of the active noise reduction headset is connected to an audio-left channel input end of the noise reduction chip 150, an audio-left channel output end of the noise reduction chip 150 is connected to the left loudspeaker 180; the left noise reduction microphone 160 and the right noise reduction microphone 170 are separately connected to the noise reduction chip 150; an end a of the resistor R1 is grounded, and an end b of the resistor R1 is connected to the microphone cable 1104 of the active noise reduction headset. Generally, a battery may be a lithium-ion battery, and voltage of the lithium-ion battery ranges from 3.2 V to 4.2 V. A size of the headset plug of the active noise reduction headset may be 3.5 millimeters with four segments.

A power source of the mobile phone is configured to supply power to the mobile phone and the active noise reduction headset. It is assumed that the power source of the mobile phone may provide power source voltage with a voltage range of 3.2 V to 4.2 V, and output voltage of the mobile phone is 5 V. It should be noted that, in this embodiment of the present invention, the microphone cable of the active noise reduction headset is used as a power cable of the active noise reduction headset, and the mobile phone supplies power to the active noise reduction headset by using the microphone cable of the active noise reduction headset.

In a case in which the microphone cable of the active noise reduction headset is not occupied, that is, in a case in which a user does not use a microphone of the active noise reduction headset when the mobile phone is in a standby state or not in a conversation state of a voice service, it is assumed that the user listens to music by using the mobile phone connected to the active noise reduction headset when the power source voltage of the mobile phone is 4 V, and the microphone cable of the active noise reduction headset is connected to the end b of the resistor R2; first, a voltage step-up chip increases the power source voltage 4 V provided by the power source of the mobile phone to output voltage 5 V of the mobile phone, performs voltage division as minimum as possible by using the resistor R2, and transmits, by using the microphone cable of the active noise reduction headset, a 5 V voltage signal after voltage division to the charging chip of the active noise reduction headset; then the charging chip decreases, according to voltage of a battery, the 5 V voltage after voltage division to voltage that helps charge the battery. It is assumed that the 5 V voltage after voltage division is decreased to 4 V voltage, the charging chip transmits the 4 V voltage to the battery to charge the battery, and the charging chip transmits the 4 V voltage to the voltage step-down chip. The voltage step-down chip then decreases, according to a power supply requirement of the noise reduction chip, the 4 V voltage to voltage that helps supply power to the noise reduction chip, and it is assumed that the 4 V voltage is decreased to 1.8 V to supply power to the noise reduction chip.

In addition, the central processing unit transmits the played music to the audio multimedia digital signal codec by using the audio bus I2S, the left audio output end m of the audio multimedia digital signal codec transmits the played music to the audio-left channel output end of the noise reduction chip by using an audio-left channel cable of the headset plug of the active noise reduction headset, and the right audio output end n of the audio multimedia digital signal codec transmits the played music to the audio-right channel output end of the noise reduction chip by using an audio-right channel cable of the headset plug of the active noise reduction headset, and the noise reduction chip transmits the music by using the left loudspeaker and the right loudspeaker. The left noise reduction microphone and the right noise reduction microphone receive external noise, and transmit the external noise to the noise reduction chip. The noise reduction chip processes the noise.

Further, when the user presses a call answering button of the active noise reduction headset, a first current is generated, the button switch Q is connected, and the resistor R1 is connected to the resistor R2 in series. Consequently, a relatively large current flows through the resistor R2, for example, a 100-mA current. In addition, a relatively large voltage difference is generated between two ends of the resistor R2. The comparator obtains voltage at the two ends of the resistor R2, and then compares the voltage at the two ends of the resistor R2 to obtain the voltage difference, generates an interrupt signal according to the voltage difference, and transmits the interrupt signal to the central processing unit. The central processing unit interrupts or switches the music according to the interrupt signal. For example, it is assumed that the resistor R1 is 40 ohm, and the resistor R2 is 10 ohm, when the resistor R1 is connected to the resistor R2 in series, that is, 5 is divided by 50 ohm to obtain a current 0.1 A, voltage at the end b of the resistor R2 is 4 V, voltage at the end a of the resistor R2 is 5 V, and the voltage difference between the two ends of the resistor R2 is 1 V. Consequently, the comparator outputs an interrupt signal of a low level. It should be noted that, resistance of the resistor R2 cannot be too large, and the resistor R2 may be less than the resistor R1. If a value of the resistor R2 is relatively large, voltage divided from the power source voltage of the mobile phone is too large. Consequently, the mobile phone may not supply power to the active noise reduction headset.

As shown in FIG. 15, a difference between an active noise reduction headset shown in FIG. 15 and that is shown in FIG. 11 is that, in addition to R1 and Q1 that are connected in series (a connection manner of a circuit is the same as that in FIG. 11) in FIG. 11, the microphone 200 is further connected to, in parallel, R3 and a switch Q3 that are connected in series and R5 and a switch Q5 that are connected in series.

When a user presses a call answering button of the active noise reduction headset, the button switch Q1 is connected, and the resistor R1 and the resistor R2 are connected in series. A manner of implementing voltage division by using the resistor R1 and the resistor R2 is the same as the implementation manner in FIG. 11. After the button switch Q1 is connected, the resistor R1 and the resistor R2 are connected in series. A level signal that is output by the comparator 80 and obtained according to the voltage difference between the two ends of the resistor R2 is a first level.

When a user presses the call answering button of the active noise reduction headset, the button switch Q3 is connected, and the resistor R3 and the resistor R2 are connected in series. A manner of implementing voltage division by using the resistor R3 and the resistor R2 is the same as the implementation manner in FIG. 11. After the button switch Q2 is connected, the resistor R3 and the resistor R2 are connected in series. A level signal that is output by the comparator 80 and obtained according to the voltage difference between the two ends of the resistor R2 is a second level.

Alternatively, when a user triggers the call answering button of the active noise reduction headset, the button switch Q5 is connected, and the resistor R5 and the resistor R2 are connected in series. A manner of implementing voltage division by using the resistor R5 and the resistor R2 is the same as the implementation manner in FIG. 11. After the button switch Q3 is connected, the resistor R5 and the resistor R2 are connected in series. A level signal that is output by the comparator 80 and obtained according to the voltage difference between the two ends of the resistor R2 is a third level. The foregoing first level, second level, and third level may be different from each other.

In a case in which the microphone cable of the active noise reduction headset is occupied, that is, in a case in which the user is connected to the mobile phone by using the active noise reduction headset, the mobile phone is in a conversation state of a voice service, and when the microphone cable of the active noise reduction headset is occupied because after the microphone cable of the active noise reduction headset receives a voice signal of the user, the voice signal is output by using the microphone cable of the active noise reduction headset, the microphone cable of the active noise reduction headset is connected to a headset microphone cable M of the audio multimedia digital signal codec, and transmits a voice of the user to the audio multimedia digital signal codec. The left audio output end m of the audio multimedia digital signal codec transmits the received voice to the audio-left channel output end of the noise reduction chip by using the audio-left channel cable of the headset plug of the active noise reduction headset, and the right audio output end n of the audio multimedia digital signal codec transmits the received voice to the audio-right channel output end of the noise reduction chip by using the audio-right channel cable of the headset plug of the active noise reduction headset; the noise reduction chip then outputs the received voice by using the left loudspeaker and the right loudspeaker. The left noise reduction microphone and the right noise reduction microphone receive external noise, and transmit the external noise to the noise reduction chip. The noise reduction chip processes the noise. It should be noted that, the noise reduction chip supplies power to the noise reduction chip by using electric energy stored by the battery.

It should be noted that, when the active noise reduction headset is connected to a terminal that cannot supply power to the active noise reduction headset, power may be supplied to the noise reduction chip by using the electric energy stored by the battery of the active noise reduction headset.

Specially, because the active noise reduction headset can obtain the electric energy by using the mobile phone connected to the active noise reduction headset, a capacity of the battery of the active noise reduction headset may be designed relatively small or the active noise reduction headset may have no battery, so that a volume of the active noise reduction headset is relatively small. For example, the capacity of the battery of the active noise reduction headset may be 20 mA. Compared with the prior art, the mobile phone connected to the active noise reduction headset can supply power to the active noise reduction headset, so that the noise reduction chip of the active noise reduction headset implements a noise reduction function. This can both effectively resolve a problem that a power supply operation of the active noise reduction headset is highly complex, and improve appearance of the active noise reduction headset, so that it is relatively convenient for a user to use and carry, and a level of user experience is relatively high.

Cables of a headset plug of the active noise reduction headset according to this embodiment of the present invention are successively an audio-left channel cable, an audio-right channel cable, a ground cable, and a microphone cable from left to right, which are provided for exemplary description only. There may be another connection method in practical application, which is not limited herein.

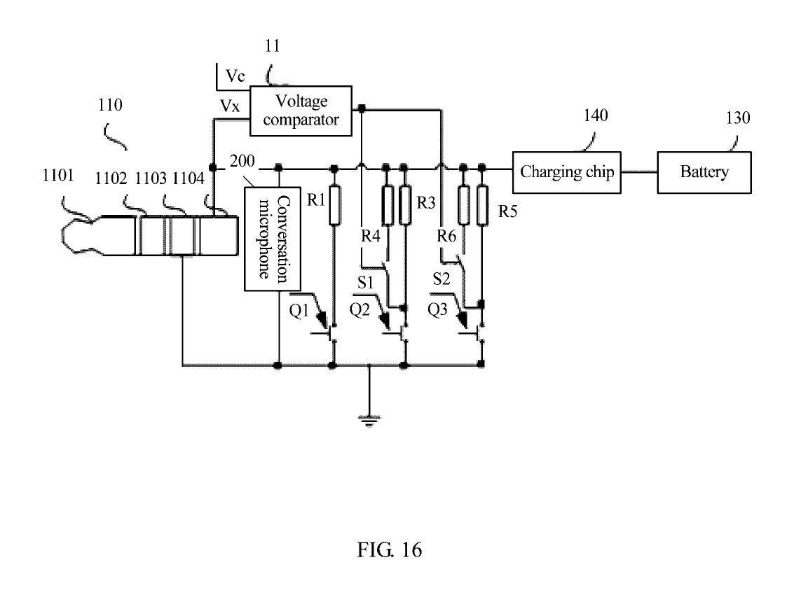

In another embodiment, exemplarily, based on the description in FIG. 16, FIG. 16 is a circuit diagram in a dashed line box in FIG. 15. R3 is connected to R4 and a switch 51 in parallel, and R5 is connected to R6 and a switch S2 in parallel. The microphone cable 1104 is further connected to a voltage comparator 11 in series. Voltage at one input end of the voltage comparator is Vx, and voltage at the other input end of the voltage comparator is Vc. Vx is charging voltage of the active noise reduction headset, and generally may be 5 V. Vc is voltage provided by the power source of the mobile phone connected to the active noise reduction headset, and generally may be 2.8 V. Because 5 V is greater than 2.8 V, a signal output by the voltage comparator makes both the switch 51 and the switch S2 connected. In this case, the resistors R3 and R4 are connected in parallel, and the resistors R5 and R6 are connected in parallel.

When a button Q2 is pressed, a resistor formed by the resistors R3 and R4 being connected in parallel is connected to the resistor R2 in series. The level signal that is output by the comparator 80 and obtained according to the voltage difference between the two ends of the resistor R2 in FIG. 10 is the second level.

When a button Q3 is pressed, a resistor formed by the resistors R5 and R6 being connected in parallel is connected to the resistor R2 in series. The level signal that is output by the comparator 80 and obtained according to the voltage difference between the two ends of the resistor R2 in FIG. 10 is the third level.

The foregoing first level, second level, and third level may be different from each other.

Two ends of the fixed resistor R3 are connected, in parallel, to a series connection circuit formed by the switch 51 and the resistor R4, and two ends of the fixed resistor R5 are connected, in parallel, to a series connection circuit formed by the switch S2 and the resistor R6. Therefore, the active noise reduction headset may be compatible with various active noise reduction headsets that support a charging function, be compatible with various mobile phones with an active noise reduction headset that does not support a charging function, and be compatible with various mobile phones that do not support an active noise reduction headset. For example, the active noise reduction headset can be connected to various mobile phones such as a Huawei mobile phone, a Xiaomi mobile phone, an iPhone, or a Samsung mobile phone.

In another embodiment, exemplarily, based on the description in FIG. 10, it is assumed that a terminal is a mobile phone, and it is assumed that cables of a headset plug of an active noise reduction headset are successively an audio-left channel cable, an audio-right channel cable, a ground cable, and a microphone cable from left to right, and the active noise reduction headset is connected to the mobile phone, that is, the headset plug of the active noise reduction headset is inserted into a headset jack of the mobile phone. The mobile phone includes: a power source 60, a voltage step-up chip 70, a resistor R2, a comparator 80, an audio multimedia digital signal codec 90, and a central processing unit 100.

The power source 60 is separately connected to an input end of the voltage step-up chip 70 and an input end of the audio multimedia digital signal codec 90; an end a of the resistor R2 is connected to a first input end of the comparator 80, and an end b of the resistor R2 is separately connected to a microphone cable 1104 of the active noise reduction headset and a second input end of the comparator 80; an output end of the comparator 80 is connected to the central processing unit 100; a left audio output end m of the audio multimedia digital signal codec 90 is connected to an audio-left channel cable 1101 of the headset plug 110 of the active noise reduction headset, a right audio output end n of the audio multimedia digital signal codec 90 is connected to an audio-right channel cable 1102 of the headset plug 110 of the active noise reduction headset, and the audio multimedia digital signal codec 90 is connected to the central processing unit 100 by using an audio bus I2S. It should be noted that, a microphone cable 1104 of the headset plug 110 of the active noise reduction headset may be connected to a headset microphone cable M of the audio multimedia digital signal codec 90, or may be connected to the end b of the resistor R2; and the power source may be a lithium-ion battery.

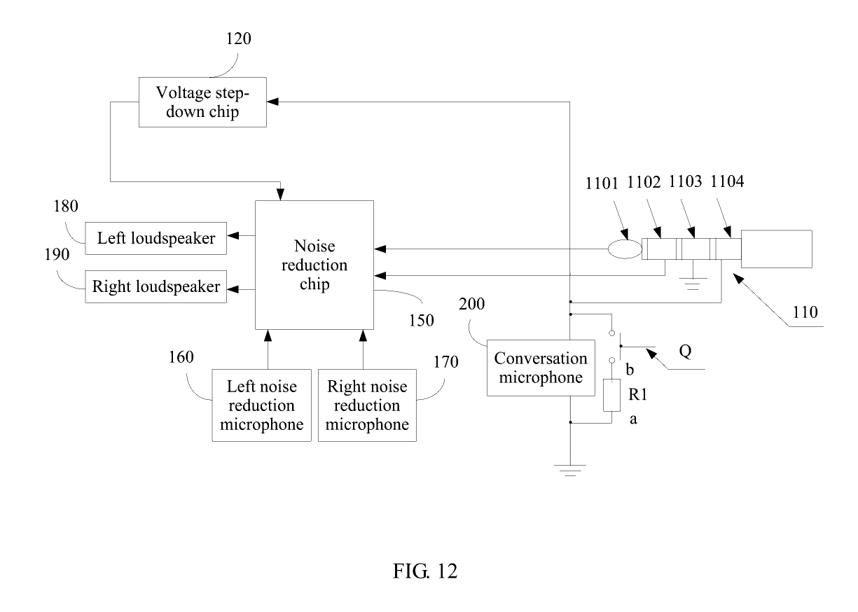

As shown in FIG. 12, an active noise reduction headset includes: the headset plug 110 of the active noise reduction headset, a voltage step-down chip 120, a noise reduction chip 150, a left noise reduction microphone 160, a right noise reduction microphone 170, a left loudspeaker 180, a right loudspeaker 190, a conversation microphone 200, a resistor R1, and a button switch Q. The headset plug 110 of the active noise reduction headset includes the audio-left channel cable 1101, the audio-right channel cable 1102, a ground cable 1103, and the microphone cable 1104.

The microphone cable 1104 of the active noise reduction headset is connected to an input end of the voltage step-down chip 120 and one end of the conversation microphone 200, the other end of the conversation microphone 200 is grounded, an output end of the voltage step-down chip 120 is connected to the noise reduction chip 150, the audio-right channel cable 1102 of the active noise reduction headset is connected to an audio-right channel input end of the noise reduction chip 150, an audio-right channel output end of the noise reduction chip 150 is connected to the right loudspeaker 190, the audio-left channel cable 1101 of the active noise reduction headset is connected to an audio-left channel input end of the noise reduction chip 150, an audio-left channel output end of the noise reduction chip 150 is connected to the left loudspeaker 180; the left noise reduction microphone 160 and the right noise reduction microphone 170 are separately connected to the noise reduction chip 150; an end a of the resistor R1 is grounded, and an end b of the resistor R1 is connected to the microphone cable 1104 of the active noise reduction headset. A size of the headset plug of the active noise reduction headset may be 3.5 millimeters with four segments.

A power source of the mobile phone is configured to supply power to the mobile phone and the active noise reduction headset. It is assumed that the power source of the mobile phone may provide power source voltage with a voltage range of 3.2 V to 4.2 V, and output voltage of the mobile phone is 5 V. It should be noted that, in this embodiment of the present invention, the microphone cable of the active noise reduction headset is used as a power cable of the active noise reduction headset, and the mobile phone supplies power to the active noise reduction headset by using the microphone cable of the active noise reduction headset.

In a case in which the microphone cable of the active noise reduction headset is not occupied, that is, in a case in which a user does not use a microphone of the active noise reduction headset when the mobile phone is in a standby state or not in a conversation state of a voice service, it is assumed that the user listens to music by using the mobile phone connected to the active noise reduction headset when the power source voltage of the mobile phone is 4 V, and the microphone cable of the active noise reduction headset is connected to the end b of the resistor R2; first, a voltage step-up chip increases the 4 V power source voltage provided by the power source of the mobile phone to 5 V output voltage of the mobile phone, and performs voltage division as minimum as possible by using the resistor R2, transmits, by using the microphone cable of the active noise reduction headset, a 5 V voltage signal after voltage division to the voltage step-down chip of the active noise reduction headset; then the voltage step-down chip decreases, according to a power supply requirement of the noise reduction chip, the 5 V voltage after voltage division to voltage that helps supply power to the noise reduction chip, and it is assumed that the 5 V voltage after voltage division is decreased to 1.8 V to supply power to the noise reduction chip.

In addition, the central processing unit transmits the played music to the audio multimedia digital signal codec by using the audio bus I2S, the left audio output end m of the audio multimedia digital signal codec transmits the played music to the audio-left channel output end of the noise reduction chip by using an audio-left channel cable of the headset plug of the active noise reduction headset, and the right audio output end n of the audio multimedia digital signal codec transmits the played music to the audio-right channel output end of the noise reduction chip by using an audio-right channel cable of the headset plug of the active noise reduction headset, and the noise reduction chip transmits the music by using the left loudspeaker and the right loudspeaker. The left noise reduction microphone and the right noise reduction microphone receive external noise, and transmit the external noise to the noise reduction chip. The noise reduction chip processes the noise.

Further, when the user presses a call answering button of the active noise reduction headset, a first current is generated, the button switch Q is connected, and the resistor R1 is connected to the resistor R2 in series. Consequently, a relatively large current flows through the resistor R2, for example, a 100-mA current. In addition, a relatively large voltage difference is generated between two ends of the resistor R2. The comparator obtains voltage at the two ends of the resistor R2, and then compares the voltage at the two ends of the resistor R2 to obtain the voltage difference, generates an interrupt signal according to the voltage difference, and transmits the interrupt signal to the central processing unit. The central processing unit interrupts or switches the music according to the interrupt signal. For example, it is assumed that the resistor R1 is 40 ohm, and the resistor R2 is 10 ohm, when the resistor R1 is connected to the resistor R2 in series, that is, 5 is divided by 50 ohm to obtain a current 0.1 A, voltage at the end b of the resistor R2 is 4 V, voltage at the end a of the resistor R2 is 5 V, and the voltage difference between the two ends of the resistor R2 is 1 V. Consequently, the comparator outputs an interrupt signal of a low level, and song switch, song suspending, or the like may be performed. It should be noted that, resistance of the resistor R2 cannot be too large, and the resistor R2 may be less than the resistor R1. If a value of the resistor R2 is relatively large, voltage divided from the power source voltage of the mobile phone is too large. Consequently, the mobile phone may not supply power to the active noise reduction headset.

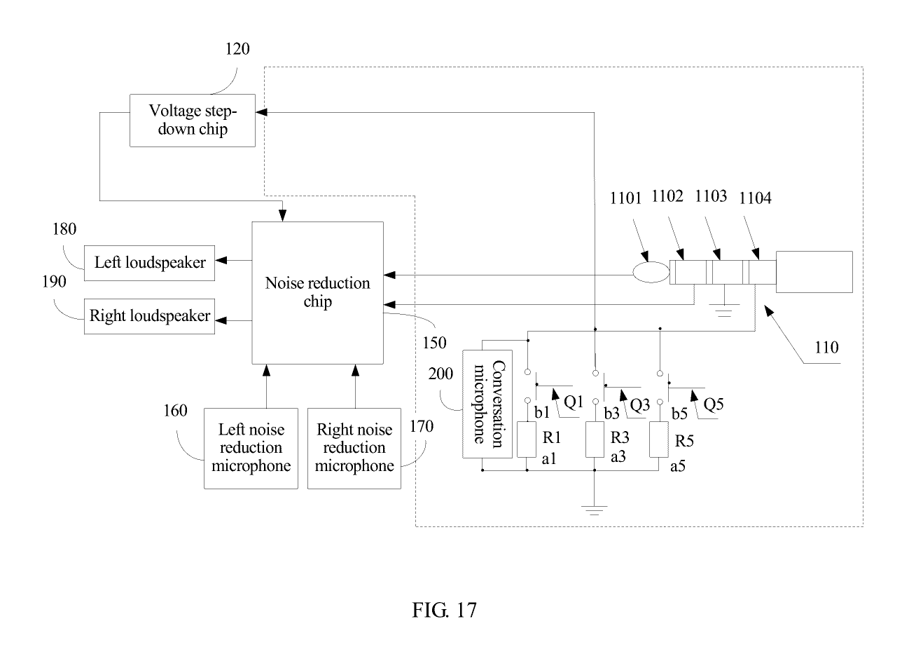

As shown in FIG. 17, a difference between an active noise reduction headset shown in FIG. 17 and that is shown in FIG. 12 is that, in addition to R1 and Q1 that are connected in series (a connection manner of a circuit is the same as that in FIG. 11) in FIG. 11, the microphone 200 is further connected to, in parallel, R3 and Q3 that are connected in series and R5 and Q5 that are connected in series.

When the button Q1 in the active noise reduction headset shown in FIG. 17 is pressed, the resistor R1 in FIG. 17 and the resistor R2 in the mobile phone shown in FIG. 10 are connected in series, and the terminal receives a first current that is transmitted by the microphone cable of the active noise reduction headset and that flows through the microphone cable of the active noise reduction headset. A voltage difference between two ends of the resistor R2 in FIG. 10 is obtained according to the first current that flows through the resistor R2 in FIG. 10, and the voltage difference is input into the comparator 80 in FIG. 10. The comparator 80 in FIG. 10 outputs a first level according to the input voltage difference, and inputs the first level to a central processing unit 100 of the mobile phone, so that the central processing unit 100 of the mobile phone controls an audio multimedia digital signal codec 90 to output a first control signal, and sends the first control signal to a headset plug 110 of the active noise reduction headset, so as to control interruption or switch of the transmit signal of the terminal.

When the button Q3 in the active noise reduction headset shown in FIG. 17 is pressed, the resistor R3 in FIG. 17 and the resistor R2 in the mobile phone shown in FIG. 10 are connected in series, and the terminal receives a second current that is transmitted by the microphone cable of the active noise reduction headset and that flows through the microphone cable of the active noise reduction headset. A voltage difference between two ends of the resistor R2 in FIG. 10 is obtained according to the second current that flows through the resistor R2 in FIG. 10, and the voltage difference is input into the comparator 80 in FIG. 10. The comparator 80 in FIG. 10 outputs a second level according to the input voltage difference, and inputs the second level to the central processing unit 100 of the mobile phone, so that the central processing unit 100 of the mobile phone controls the audio multimedia digital signal codec 90 to output a second control signal, and sends the second control signal to the headset plug 110 of the active noise reduction headset, so as to control increase of volume of a voice signal transmitted by the terminal to the active noise reduction headset.

When the button Q5 in the active noise reduction headset shown in FIG. 17 is pressed, the resistor R5 in FIG. 17 and the resistor R2 in the mobile phone shown in FIG. 10 are connected in series, and the terminal receives a third current that is transmitted by the microphone cable of the active noise reduction headset and that flows through the microphone cable of the active noise reduction headset. A voltage difference between two ends of the resistor R2 in FIG. 10 is obtained according to the third current that flows through the resistor R2 in FIG. 10, and the voltage difference is input into the comparator 80 in FIG. 10. The comparator 80 in FIG. 10 outputs a third level according to the input voltage difference, and inputs the third level to the central processing unit 100 of the mobile phone, so that the central processing unit 100 of the mobile phone controls the audio multimedia digital signal codec 90 to output a third control signal, and sends the third control signal to the headset plug 110 of the active noise reduction headset, so as to control decrease of volume of a voice signal transmitted by the terminal to the active noise reduction headset. A circuit diagram in a dashed line box in FIG. 17 may be similar to the circuit diagram shown in FIG. 16. The circuit diagram in the dashed line box in FIG. 17 does not include the charging chip 140 and the battery 130. Other circuit components are similar to those in FIG. 16, and details are not described herein.

In a case in which the microphone cable of the active noise reduction headset is occupied, that is, in a case in which the mobile phone is in a conversation state of a voice service, and when the microphone cable of the active noise reduction headset is occupied because after a microphone of the active noise reduction headset receives a voice signal of a user, the voice signal is output by using the microphone cable of the active noise reduction headset, the microphone cable of the active noise reduction headset is connected to a headset microphone cable M of the audio multimedia digital signal codec, and transmits a voice of the user to the audio multimedia digital signal codec. The left audio output end m of the audio multimedia digital signal codec transmits the received voice to the audio-left channel output end of the noise reduction chip by using the audio-left channel cable of the headset plug of the active noise reduction headset, and the right audio output end n of the audio multimedia digital signal codec transmits the received voice to the audio-right channel output end of the noise reduction chip by using the audio-right channel cable of the headset plug of the active noise reduction headset; the noise reduction chip then outputs the received voice by using the left loudspeaker and the right loudspeaker. It should be noted that, in this case, the active noise reduction headset cannot supply power to the noise reduction chip by using the microphone cable.

Specially, because the active noise reduction headset can obtain the electric energy by using the mobile phone connected to the active noise reduction headset, the active noise reduction headset may have no battery, so that a volume of the active noise reduction headset is relatively small. Compared with the prior art, the mobile phone connected to the active noise reduction headset can supply power to the active noise reduction headset, so that the noise reduction chip of the active noise reduction headset implements a noise reduction function. This can both effectively resolve a problem that a power supply operation of the active noise reduction headset is highly complex, and improve appearance of the active noise reduction headset, so that it is relatively convenient for a user to use and carry, and a level of user experience is relatively high.

Cables of a headset plug of the active noise reduction headset according to this embodiment of the present invention are successively an audio-left channel cable, an audio-right channel cable, a ground cable, and a microphone cable from left to right, which are provided for exemplary description only. There may be another connection method in practical application, which is not limited herein.

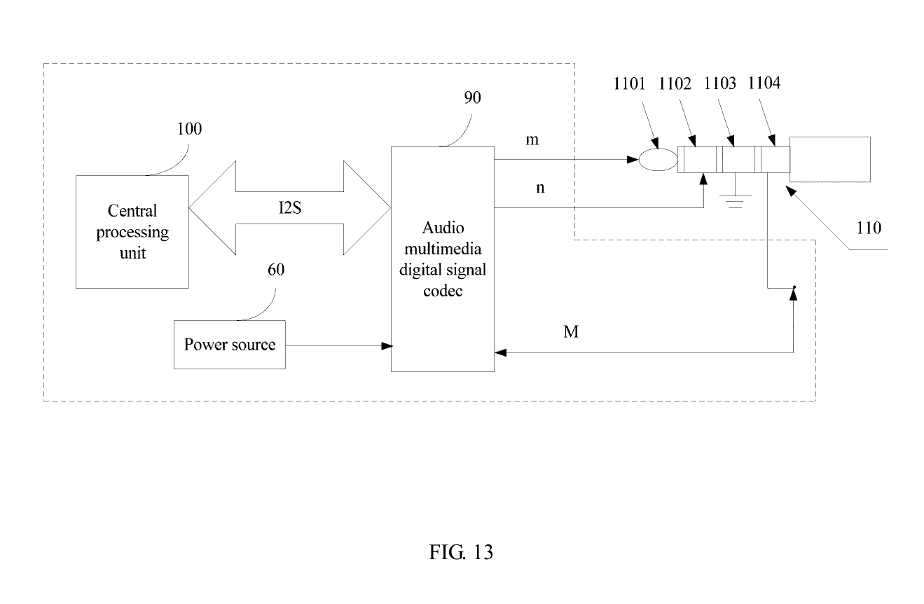

In yet another embodiment, exemplarily, it is assumed that a terminal is a mobile phone, and it is assumed that cables of a headset plug of an active noise reduction headset are successively an audio-left channel cable, an audio-right channel cable, a ground cable, and a microphone cable from left to right, and the active noise reduction headset is connected to the mobile phone, that is, the headset plug of the active noise reduction headset is inserted into a headset jack of the mobile phone. As shown in FIG. 13, the mobile phone includes: a power source 60, an audio multimedia digital signal codec 90, and a central processing unit 100.

The power source 60 is connected to an input end of the audio multimedia digital signal codec 90; the left audio output end m of the audio multimedia digital signal codec 90 is connected to an audio-left channel cable 1101 of a headset plug 110 of the active noise reduction headset, a right audio output end n of the audio multimedia digital signal codec 90 is connected to an audio-right channel cable 1102 of the headset plug 110 of the active noise reduction headset, the audio multimedia digital signal codec 90 is connected to the central processing unit 100 by using an audio bus I2S, and a headset microphone cable M of the audio multimedia digital signal codec 90 is connected to a microphone cable 1104 of the headset plug 110 of the active noise reduction headset. The power source may be a lithium-ion battery.

As shown in FIG. 11, the active noise reduction headset may include: the headset plug 110 of the active noise reduction headset, a voltage step-down chip 120, a battery 130, a charging chip 140, a noise reduction chip 150, a left noise reduction microphone 160, a right noise reduction microphone 170, a left loudspeaker 180, a right loudspeaker 190, a conversation microphone 200, a resistor R1, and a button switch Q. The headset plug 110 of the active noise reduction headset includes the audio-left channel cable 1101, the audio-right channel cable 1102, a ground cable 1103, and the microphone cable 1104.

The microphone cable 1104 of the active noise reduction headset is connected to an input end of the charging chip 140 and one end of the conversation microphone 200, the other end of the conversation microphone 200 is grounded, an output end of the charging chip 140 is connected to an input end of the voltage step-down chip 120, the battery 130 is separately connected to the output end of the charging chip 140 and the input end of the voltage step-down chip 120, an output end of the voltage step-down chip 120 is connected to the noise reduction chip 150, the audio-right channel cable 1102 of the active noise reduction headset is connected to an audio-right channel input end of the noise reduction chip 150, an audio-right channel output end of the noise reduction chip 150 is connected to the right loudspeaker 190, the audio-left channel cable 1101 of the active noise reduction headset is connected to an audio-left channel input end of the noise reduction chip 150, an audio-left channel output end of the noise reduction chip 150 is connected to the left loudspeaker 180; the left noise reduction microphone 160 and the right noise reduction microphone 170 are separately connected to the noise reduction chip 150; an end a of the resistor R1 is grounded, and an end b of the resistor R1 is connected to the microphone cable 1104 of the active noise reduction headset. Generally, a battery may be a lithium-ion battery, and voltage of the lithium-ion battery ranges from 3.2 V to 4.2 V. A size of the headset plug of the active noise reduction headset may be 3.5 millimeters with four segments.

In this embodiment of the present invention, it is assumed that the mobile phone cannot supply power to the active noise reduction headset, the battery of the active noise reduction headset stores electric energy, and voltage is 4 V.

In a case in which a user does not use a microphone of the active noise reduction headset when the mobile phone is in a standby state or not in a conversation state of a voice service, when the user listens to music by using the mobile phone connected to the active noise reduction headset, the battery of the active noise reduction headset transmits the 4 V voltage to a voltage step-down chip; the voltage step-down chip then decreases, according to a power supply requirement of the noise reduction chip, the 4 V voltage to voltage that helps supply power to the noise reduction chip. It is assumed that the 4 V voltage is decreased to 1.8 V to supply power to the noise reduction chip.

In addition, the central processing unit transmits played music to the audio multimedia digital signal codec by using the audio bus I2S, the left audio output end m of the audio multimedia digital signal codec transmits the played music to an audio-left channel output end of the noise reduction chip by using an audio-left channel cable of a headset plug of the active noise reduction headset, and a right audio output end n of the audio multimedia digital signal codec transmits the played music to an audio-right channel output end of the noise reduction chip by using an audio-right channel cable of the headset plug of the active noise reduction headset, and the noise reduction chip transmits the music by using a left loudspeaker and a right loudspeaker. The left noise reduction microphone and the right noise reduction microphone receive external noise, and transmit the external noise to the noise reduction chip. The noise reduction chip processes the noise.

In a case in which the microphone cable of the active noise reduction headset is occupied, that is, in a case in which the user is connected to the mobile phone by using the active noise reduction headset, the mobile phone is in a conversation state of a voice service, and when the microphone cable of the active noise reduction headset is occupied because after the microphone cable of the active noise reduction headset receives a voice signal of the user, the voice signal is output by using the microphone cable of the active noise reduction headset, the microphone cable of the active noise reduction headset is connected to a headset microphone cable M of the audio multimedia digital signal codec, and transmits a voice of the user to the audio multimedia digital signal codec. The left audio output end m of the audio multimedia digital signal codec transmits the received voice to the audio-left channel output end of the noise reduction chip by using the audio-left channel cable of the headset plug of the active noise reduction headset, and the right audio output end n of the audio multimedia digital signal codec transmits the received voice to the audio-right channel output end of the noise reduction chip by using the audio-right channel cable of the headset plug of the active noise reduction headset; the noise reduction chip then outputs the received voice by using the left loudspeaker and the right loudspeaker. The left noise reduction microphone and the right noise reduction microphone receive external noise, and transmit the external noise to the noise reduction chip. The noise reduction chip processes the noise. It should be noted that, the battery of the active noise reduction headset transmits the 4 V voltage to the voltage step-down chip; the voltage step-down chip then decreases, according to a power supply requirement of the noise reduction chip, the 4 V voltage to voltage that helps supply power to the noise reduction chip. It is assumed that the 4 V voltage is decreased to 1.8 V to supply power to the noise reduction chip.

Specially, a capacity of the battery of the active noise reduction headset may be designed relatively small, so that a volume of the active noise reduction headset is relatively small, for example, when the capacity of the battery of the active noise reduction headset may be 20 mA. Compared with the prior art, the battery of the active noise reduction headset supplies power to the noise reduction chip of the active noise reduction headset, so that the noise reduction chip of the active noise reduction headset implements a noise reduction function. This can both effectively resolve a problem that a power supply operation of the active noise reduction headset is highly complex, and improve appearance of the active noise reduction headset, so that it is relatively convenient for a user to use and carry, and a level of user experience is relatively high. If electric energy of the battery of the active noise reduction headset is insufficient, the active noise reduction headset may also be connected to the mobile phone that provides electric energy to the active noise reduction headset. The active noise reduction headset obtains electric energy by using the mobile phone, and charges the battery of the active noise reduction headset.

Cables of a headset plug of the active noise reduction headset according to this embodiment of the present invention are successively an audio-left channel cable, an audio-right channel cable, a ground cable, and a microphone cable from left to right, which are provided for exemplary description only. There may be another connection method in practical application, which is not limited herein.

An active noise reduction headset according to the present invention may be connected to a mobile phone that cannot provide electric energy to the active noise reduction headset, and power is supplied to a noise reduction chip of the active noise reduction headset by using a battery of the active noise reduction headset, so that the noise reduction chip of the active noise reduction headset implements a noise reduction function. The active noise reduction headset may further be connected to a mobile phone that provides electric energy to the active noise reduction headset, and power is supplied to the noise reduction chip of the active noise reduction headset by using the electric energy of the mobile phone, so that the noise reduction chip of the active noise reduction headset implements the noise reduction function. In addition, the mobile phone charges the battery of the active noise reduction headset. Further, after the battery of the active noise reduction headset is fully charged, if the mobile phone is still connected to the active noise reduction headset, power may further be supplied to the active noise reduction headset. In this case, the active noise reduction headset can supply power to the noise reduction chip of the active noise reduction headset by using the electric energy of the battery of the active noise reduction headset, or can supply power to the noise reduction chip of the active noise reduction headset by using the electric energy of the mobile phone, and the latter is preferred. This can avoid a case in which when the battery of the active noise reduction headset is used after fully charged, lifetime of the battery is shortened because the battery is repeatedly charged by using the electric energy of the mobile phone. Specially, the active noise reduction headset may have no battery, and is directly connected to a mobile phone that provides electric energy to the active noise reduction headset. Power is supplied to the noise reduction chip of the active noise reduction headset by using the electric energy of the mobile phone, so that the noise reduction chip of the active noise reduction headset implements a noise reduction function. It should be noted that a capacity of the battery of the active noise reduction headset may be designed relatively small, so that a volume of the active noise reduction headset is relatively small, for example, when the capacity of the battery of the active noise reduction headset may be 20 mA. This can both effectively resolve a problem that a power supply operation of the active noise reduction headset is highly complex, and improve appearance of the active noise reduction headset, so that it is relatively convenient for a user to use and carry, and a level of user experience is relatively high.

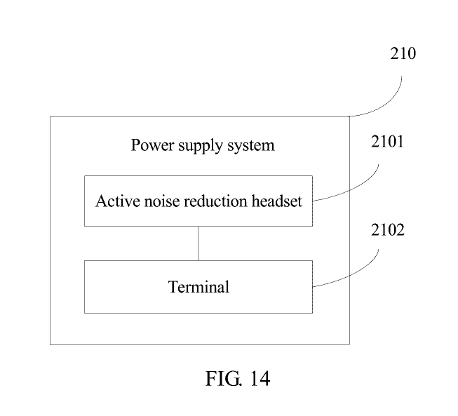

An embodiment of the present invention provides a power supply system 210. As shown in FIG. 14, the power supply system 210 includes an active noise reduction headset 2101 and a terminal 2102.

The terminal 2102 is configured to obtain a signal of power source voltage provided by a power source of the terminal, process the signal of the power source voltage of the terminal to obtain a signal of first voltage, where the power source voltage is less than the first voltage, and transmit the signal of the first voltage to the active noise reduction headset, so that the active noise reduction headset processes the signal of the first voltage to obtain a signal of second voltage, where the signal of the second voltage is transmitted to a noise reduction chip of the active noise reduction headset, so that the noise reduction chip of the active noise reduction headset obtains the signal of the second voltage to implement a noise reduction function, where the second voltage is less than the first voltage.

The active noise reduction headset 2101 is configured to receive the signal of the first voltage transmitted by the terminal, and process the signal of the first voltage to obtain the signal of the second voltage, where the second voltage is less than the first voltage, and the signal of the second voltage is transmitted to the noise reduction chip of the active noise reduction headset, so that the noise reduction chip of the active noise reduction headset obtains the signal of the second voltage to implement a noise reduction function.

According to the method for supplying power to an active noise reduction headset provided in this embodiment of the present invention, after the active noise reduction headset is connected to a terminal, first, the terminal processes a signal of power source voltage of the terminal to obtain a signal of first voltage, and transmits the signal of the first voltage to the active noise reduction headset; then, the active noise reduction headset receives the signal of the first voltage transmitted by the terminal, processes the signal of the first voltage to obtain a signal of second voltage, transmits the signal of the second voltage to a noise reduction chip of the active noise reduction headset, so that the noise reduction chip of the active noise reduction headset obtains the signal of the second voltage to implement a noise reduction function. Compared with the prior art, the terminal connected to the active noise reduction headset can supply power to the active noise reduction headset, so that the noise reduction chip of the active noise reduction headset implements the noise reduction function, which can effectively resolve a problem that a power supply operation of the active noise reduction headset is highly complex.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

The foregoing descriptions are merely specific embodiments of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

1. A method for supplying power to an active noise reduction headset, wherein the active noise reduction headset is connected to a terminal, and the method comprises:
receiving, by the active noise reduction headset, a signal that is of first voltage and that is transmitted by the terminal; and
processing, by the active noise reduction headset, the signal of the first voltage to obtain a signal of second voltage, wherein the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function; wherein
the receiving the signal that is of the first voltage and that is transmitted by the terminal comprises:
receiving, by the active noise reduction headset by using a microphone cable of the active noise reduction headset, the signal of the first voltage transmitted by the terminal.

2. The method according to claim 1, wherein the processing, by the active noise reduction headset, the signal of the first voltage to obtain a signal of second voltage comprises:
processing, by the active noise reduction headset, the signal of the first voltage to obtain a signal of third voltage, wherein the third voltage is less than the first voltage, and
the signal of the third voltage is transmitted to a rechargeable battery of the active noise reduction headset, so that the rechargeable battery stores the signal of the third voltage; and
processing, by the active noise reduction headset, the signal of the third voltage to obtain the signal of the second voltage, wherein the third voltage is greater than the second voltage.

3. The method according to claim 1, wherein after the receiving the signal that is of the first voltage and that is transmitted by the terminal, the method further comprises:
receiving, by the active noise reduction headset, a second current by using the microphone cable of the active noise reduction headset; and
transmitting, by the active noise reduction headset, the second current to the terminal by using the microphone cable of the active noise reduction headset, so that the terminal increases, according to the second current, volume of a voice signal transmitted by the terminal to the active noise reduction headset.

4. The method according to claim 1, wherein after the receiving the signal that is of the first voltage and that is transmitted by the terminal, the method further comprises:
receiving, by the active noise reduction headset, a third current by using the microphone cable of the active noise reduction headset; and
transmitting, by the active noise reduction headset, the third current to the terminal by using the microphone cable of the active noise reduction headset, so that the terminal decreases, according to the third current, volume of a voice signal transmitted by the terminal to the active noise reduction headset.

5. A method for supplying power to an active noise reduction headset, wherein the active noise reduction headset is connected to a terminal, and the method comprises:
obtaining, by the terminal, a signal of power source voltage provided by a power source of the terminal;
processing, by the terminal, the signal of the power source voltage of the terminal to obtain a signal of first voltage, wherein the power source voltage is less than the first voltage; and
transmitting, by the terminal, the signal of the first voltage to the active noise reduction headset, so that the active noise reduction headset processes the signal of the first voltage to obtain a signal of second voltage, wherein the signal of the second voltage is transmitted to a noise reduction chip of the active noise reduction headset, so that the noise reduction chip of the active noise reduction headset obtains the signal of the second voltage to implement a noise reduction function, wherein the second voltage is less than the first voltage.

6. The method according to claim 5, wherein after the transmitting the signal of the first voltage to the active noise reduction headset, the method further comprises:
receiving, by the terminal, a second current transmitted by a microphone cable of the active noise reduction headset; and
increasing, by the terminal according to the second current, volume of a voice signal transmitted by the terminal to the active noise reduction headset.

7. The method according to claim 5 or 6, wherein after the transmitting the signal of the first voltage to the active noise reduction headset, the method further comprises:
receiving, by the terminal, a third current transmitted by the microphone cable of the active noise reduction headset; and
decreasing, by the terminal according to the third current, volume of a voice signal transmitted by the terminal to the active noise reduction headset.

8. An active noise reduction headset, wherein the active noise reduction headset comprises:
a receiver circuit, configured to: after the active noise reduction headset is connected to a terminal, receive a signal that is of first voltage and that is transmitted by the terminal; and
a voltage step-down circuit, configured to process the signal of the first voltage to obtain a signal of second voltage, wherein the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function; wherein
the receiver circuit is specifically configured to:
receive, by using a microphone cable of the active noise reduction headset, the signal of the first voltage transmitted by the terminal.

9. The active noise reduction headset according to claim 8, wherein the voltage step-down circuit comprises:
a first processing circuit, configured to process the signal of the first voltage to obtain a signal of third voltage, wherein the third voltage is less than the first voltage, and
the signal of the third voltage is transmitted to a rechargeable battery of the active noise reduction headset, so that the rechargeable battery stores the signal of the third voltage; and
a second processing circuit, configured to process the signal of the third voltage to obtain the signal of the second voltage, wherein the third voltage is greater than the second voltage.

10. The active noise reduction headset according to claim 8, wherein
the receiver circuit is further configured to receive a second current by using the microphone cable of the active noise reduction headset; and
the active noise reduction headset further comprises:
a transmission circuit, configured to transmit the second current to the terminal by using the microphone cable of the active noise reduction headset, so that the terminal increases volume of a voice signal transmitted by the terminal to the active noise reduction headset.

11. The active noise reduction headset according to claim 8, wherein the receiver circuit is further configured to receive a third current by using the microphone cable of the active noise reduction headset; and
the active noise reduction headset further comprises:
the transmission circuit, configured to transmit the third current to the terminal by using the microphone cable of the active noise reduction headset, so that the terminal decreases volume of a voice signal transmitted by the terminal to the active noise reduction headset.

12. The active noise reduction headset according to claim 10, wherein the transmission circuit comprises:
a third button switch and a resistor R3, wherein one end of the resistor R3 is grounded, the other end of the resistor R3 is connected to the third button switch in series, the third button switch is connected to the microphone cable of the active noise reduction headset, and when the second current indicating that a user triggers the active noise reduction headset is received by using the microphone cable of the active noise reduction headset, the third button switch is connected to the resistor R3.

13. The active noise reduction headset according to claim 11, wherein
a fifth button switch and a resistor R5, wherein one end of the resistor R5 is grounded, the other end of the resistor R5 is connected to the fifth button switch in series, the fifth button switch is connected to the microphone cable of the active noise reduction headset, and when the third current indicating that a user triggers the active noise reduction headset is received by using the microphone cable of the active noise reduction headset, the fifth button switch is connected to the resistor R5.

14. The active noise reduction headset according to claim 13, wherein
when the third button switch is connected to the resistor R3, a current that flows through the resistor R3 is the second current;
when the fifth button switch is connected to the resistor R5, a current that flows through the resistor R5 is the third current; and
a value of the first current, a value of the second current, and a value of the third current are different from each other.

15. A terminal, wherein the terminal comprises:
a power source, configured to provide power source voltage to the terminal; and
a voltage step-up circuit, configured to process a signal of the power source voltage of the terminal to obtain a signal of first voltage, wherein the power source voltage is less than the first voltage; wherein
the voltage step-up circuit is further configured to: after the terminal is connected to an active noise reduction headset, transmit the signal of the first voltage to the active noise reduction headset, so that the active noise reduction headset processes the signal of the first voltage to obtain a signal of second voltage, wherein the signal of the second voltage is transmitted to a noise reduction chip of the active noise reduction headset, so that the noise reduction chip of the active noise reduction headset obtains the signal of the second voltage to implement a noise reduction function, wherein the second voltage is less than the first voltage; and
the voltage step-up circuit comprises:
a voltage step-up chip, wherein an input end of the voltage step-up chip is connected to an output end of the power source of the terminal, and an output end of the voltage step-up chip is connected to a microphone cable of the active noise reduction headset.

16. The terminal according to claim 15, wherein the terminal further comprises:
a processing circuit, configured to receive a second current transmitted by the microphone cable of the active noise reduction headset; wherein
the processing circuit is further configured to increase, according to the second current, volume of a voice signal transmitted by the terminal to the active noise reduction headset.

17. The terminal according to claim 15, wherein the processing circuit is further configured to receive a third current transmitted by the microphone cable of the active noise reduction headset; and
the processing circuit is further configured to decrease, according to the third current, volume of a voice signal transmitted by the terminal to the active noise reduction headset.

18. A power supply system, comprising the active noise reduction headset and the terminal;
wherein the active noise reduction headset comprises:
a receiver circuit, configured to: after the active noise reduction headset is connected to a terminal, receive a signal that is of first voltage and that is transmitted by the terminal; and
a voltage step-down circuit, configured to process the signal of the first voltage to obtain a signal of second voltage, wherein the second voltage is less than the first voltage, and
the signal of the second voltage is transmitted to a noise reduction chip of the active noise reduction headset, so that the noise reduction chip of the active noise reduction headset obtains the signal of the second voltage to implement a noise reduction function; wherein
the receiver circuit is specifically configured to:
receive, by using a microphone cable of the active noise reduction headset, the signal of the first voltage transmitted by the terminal;
wherein the terminal comprises:
a power source, configured to provide power source voltage to the terminal; and
a voltage step-up circuit, configured to process a signal of the power source voltage of the terminal to obtain a signal of first voltage, wherein the power source voltage is less than the first voltage; wherein
the voltage step-up circuit is further configured to: after the terminal is connected to an active noise reduction headset, transmit the signal of the first voltage to the active noise reduction headset, so that the active noise reduction headset processes the signal of the first voltage to obtain a signal of second voltage, wherein the signal of the second voltage is transmitted to a noise reduction chip of the active noise reduction headset, so that the noise reduction chip of the active noise reduction headset obtains the signal of the second voltage to implement a noise reduction function, wherein the second voltage is less than the first voltage; and
the voltage step-up circuit comprises:
a voltage step-up chip, wherein an input end of the voltage step-up chip is connected to an output end of the power source of the terminal, and an output end of the voltage step-up chip is connected to a microphone cable of the active noise reduction headset.
